(19) United States
(12) Patent Application Publication
(10) Pub. No.: US 2023/0333534 A1
(43) Pub. Date: Oct. 19, 2023

(54) NUMERICAL CONTROL DEVICE

(71) Applicant: FANUC CORPORATION, Minamitsuru-gun, Yamanashi (JP)

(72) Inventor: Zhaojia LIU, Yamanashi (JP)

(21) Appl. No.: 18/028,092

(22) PCT Filed: Oct. 20, 2021
(86) PCT No.: PCT/JP2021/038714

§ 371 Date: Mar. 23, 2023

(30) Foreign Application Priority Data
Oct. 26, 2020 (JP) 2020-178689

(51) Int. Cl. G05B 19/4093

(52) U.S. Cl. CPC G05B 19/40938; G05B 19/40932

(57) ABSTRACT

A numerical control device automatically generates a machining program and comprises: a linked information storage unit that stores linked information, which is tool information pertaining to a plurality of tools, a shape identifier that shows the shape that each tool can machine, and at least one G code which can be used for machining the shaped indicated by the shape identifier; a tool information acquisition unit that acquires tool information pertaining to the tool selected for machining; a shape ID information extraction unit that, using the acquired tool information, makes an enquiry to the linked information storage unit and extracts a shape identifier indicating a shape that can be machined by the tool having the acquired tool information; a machinable-shape extraction unit that extracts machinable shapes from CAD data on the basis of the extracted shape identifier; and a machinable-shape display unit that shows the extracted machinable shape.

### TECHNICAL FIELD

The present invention pertains to a numerical control device.

### BACKGROUND ART

A conventional technique for using CAD data to automatically create a machining program is known. For example, refer to Patent Document 1.

Patent Document 1: Japanese Unexamined Patent Application, Publication No. H04-315550

### DISCLOSURE OF THE INVENTION

### Problems to Be Solved by the Invention

When using CAD data to create a machining program, there is (a) a case in which a user selects a G code after selecting a machining shape and (b) a case in which a user selects a machining shape after selecting a G code.

(a) Regarding a case in which a user selects a G code after selecting a machining shape

FIG. 26A through FIG. 26D are views that illustrate an example of change to a display screen in a case where a user selects a G code after selecting a machining shape.

As illustrated in FIG. 26A, in order to create the machining product illustrated in FIG. 27, when the user selects a tool, a machining program that includes the tool (for example, tool code “T10”) selected in a left-side region of the display screen is displayed. After the tool is selected, when the user selects CAD data illustrated in FIG. 28A and FIG. 28B for the machining product in FIG. 27, all shapes included in the CAD data are displayed in a right-side region of the screen, without narrowing down shapes that can be machined by the selected tool code (tool code “T10”). For example, as illustrated in FIG. 26A, when the user selects a top-right circular portion in order to perform deep-hole drilling of the circular portion, as illustrated in FIG. 26B, all G codes are displayed in the right-side region in the screen without narrowing down G codes by the selected tool (tool code “T10”) and selected shape.

In the display screen illustrated in FIG. 26B, when “G83 peck drilling cycle” is selected by the user, a screen for setting a parameter for a cutting condition for a G code “G83” is displayed in the right-side region as illustrated in FIG. 26C. When a parameter for the cutting condition is set by the user in the display screen illustrated in FIG. 26C, a block for the G code “G83” is added to the machining program and displayed in the left-side region in the display screen illustrated in FIG. 26D. The procedure illustrated in FIG. 26A through FIG. 26D is performed for all shapes included in the CAD data, whereby a machining program is generated.

(b) Regarding a case in which a user selects a machining shape after selecting a G code

FIG. 29A and FIG. 29B are views that illustrate an example of change to a display screen in a case where a user selects a G code after selecting a machining shape.

As illustrated in FIG. 29A, when a user selects a tool, a machining program that includes the selected tool (for example, tool code “T10”) is displayed in the left-side region in the display screen, and all G codes are displayed in the right-side region of the display screen without narrowing down G codes that can be used by the selected tool (tool code “T10”). In the screen illustrated in FIG. 29A, for example, when the user selects “G83 peck drilling cycle” in order to perform deep-hole drilling and selects the machining product illustrated in FIG. 27 and the CAD data illustrated in FIG. 28A and FIG. 28B, all shapes included in the CAD data are displayed in the right-side region of the display screen without narrowing down shapes that can be machined by the selected G code “G83”, as illustrated in FIG. 29B.

In the display screen illustrated in FIG. 29B, for example, when the user selects the top-right circular portion as a shape for performing deep-hole drilling, a screen that is similar to FIG. 26C and is for setting a parameter for a cutting condition for the G code “G83” is displayed in the right-side region. When a parameter for the cutting condition is set by the user in the display screen illustrated in FIG. 26C, a block for the G code “G83” is added to the machining program and displayed, similarly to the case in FIG. 26D. The procedure illustrated in FIG. 29A, FIG. 29B, FIG. 26C, and FIG. 26D is performed for all shapes included in the CAD data, whereby a machining program is generated.

However, in any case described above, because all G codes and/or CAD data machining shapes are displayed, it takes time to select a desired G code or machining shape, and it is easy for a selection error to occur.

Accordingly, it is desired to narrow down G codes and/or machining shapes according to a selected tool so as to display the G codes and/or machining shapes.

### Means for Solving the Problems

(1) One aspect of a numerical control device according to the present disclosure is a numerical control device configured to automatically generate a machining program, the device including: an associated information storage unit configured to store associated information resulting from associating, in advance, tool information pertaining to a plurality of tools, shape identifiers indicating shapes that the plurality of tools can respectively machine, and at least one G code that can be used to machine the shape indicated by the shape identifier; a tool information acquisition unit configured to acquire tool information pertaining to a tool selected for machining; a shape ID information extraction unit configured to, using the acquired tool information to query the associated information storage unit, extract a shape identifier indicating a shape that can be machined by the tool corresponding to the acquired tool information; and a machinable-shape extraction unit configured to, based on the extracted shape identifier, extract a machinable shape from CAD data; and a machinable-shape display unit configured to display the extracted machinable shape.
(2) One aspect of a numerical control device according to the present disclosure is a numerical control device configured to automatically generate a machining program, the device including: an associated information storage unit configured to store associated information resulting from associating, in advance, tool information pertaining to a plurality of tools, shape identifiers indicating shapes that the plurality of tools can respectively machine, and at least one G code that can be used to machine the shape indicated by the shape identifier; a tool information acquisition unit configured to acquire tool information pertaining to a tool selected for machining; a usable G code extraction unit configured to, using the acquired tool information to query the associated information storage unit, extract a G code that can be used by the tool corresponding to the acquired tool information; and a usable G code display unit configured to display the extracted G code that can be used.

### EFFECTS OF THE INVENTION

By virtue of one aspect, it is possible to narrow down G codes and/or machining shapes according to a selected tool so as to display the G codes and/or machining shapes.

### BRIEF DESCRIPTION OF THE DRAWINGS

FIG. 1 is a functional block diagram illustrating an example of a functional configuration of a control system according to a first embodiment;

FIG. 2 is a view that illustrates an example of an association table;

FIG. 3A is a view that illustrates an example of a display screen for extracted machinable shapes;

FIG. 3B is a view that illustrates an example of a display screen for extracted machinable shapes;

FIG. 4 is a view that illustrates an example of a display screen for display of usable G codes that have been narrowed down;

FIG. 5A is a view that illustrates an example of a setting screen for a selected G code;

FIG. 5B is a view that illustrates an example of a display screen in which a block for a selected G code has been added;

FIG. 6 is a flow chart for describing a machining program generation process by a numerical control device 10;

FIG. 7 is a flow chart for describing a tool information acquisition process described in Step S1 in FIG. 6;

FIG. 8A is a flow chart for describing a machinable-shape extraction process described in Step S3 in FIG. 6;

FIG. 8B is a flow chart for describing the machinable-shape extraction process described in Step S3 in FIG. 6;

FIG. 9 is a flow chart for describing a selected shape acquisition process described in Step S5 in FIG. 6;

FIG. 10 is a flow chart for describing a determination process in Step S32 in FIG. 8A regarding whether a hole shape having a shape ID “1” is present in CAD data for a machining product;

FIG. 11 is a view that illustrates an example of CAD data for a hole shape;

FIG. 12 is a flow chart for describing a determination process in Step S35 in FIG. 8A regarding whether a screw shape having a shape ID “2” is present in CAD data for the machining product;

FIG. 13 is a view that illustrates an example of CAD data for a screw shape;

FIG. 14 is a flow chart for describing a determination process in Step S38 in FIG. 8A regarding whether a pocket shape having a shape ID “3” is present in CAD data for the machining product;

FIG. 15 is a view that illustrates an example of CAD data for a pocket shape;

FIG. 16 is a flow chart for describing a determination process in Step S3B in FIG. 8B regarding whether a contour shape having a shape ID “4” is present in CAD data for the machining product;

FIG. 17 is a view that illustrates an example of CAD data for a contour shape;

FIG. 18 is a flow chart for describing a determination process in Step S3E in FIG. 8B regarding whether an inclined shape having a shape ID “5” is present in CAD data for the machining product;

FIG. 19 is a view that illustrates an example of CAD data for an inclined shape;

FIG. 20 is a functional block diagram illustrating an example of a functional configuration of a control system according to a second embodiment;

FIG. 21 is a view that illustrates an example of a display screen for display of usable G codes;

FIG. 22 is a view that illustrates an example of a display screen for extracted machinable shapes;

FIG. 23 is a flow chart for describing a machining program generation process by a numerical control device;

FIG. 24 is a view that illustrates an example of a setting screen for a case of a contouring outer wall rough machining “G1060” G code;

FIG. 25 is a view that illustrates an example of screen in which a block for a selected G code has been added;

FIG. 26A is a view that illustrate an example of change to a display screen in a case where a user selects a G code after selecting a machining shape;

FIG. 26B is a view that illustrate an example of change to a display screen in a case where a user selects a G code after selecting a machining shape;

FIG. 26C is a view that illustrate an example of change to a display screen in a case where a user selects a G code after selecting a machining shape;

FIG. 26D is a view that illustrate an example of change to a display screen in a case where a user selects a G code after selecting a machining shape;

FIG. 27 illustrates an example of a machining product;

FIG. 28A is a view that illustrates an example of CAD data for the machining product in FIG. 27;

FIG. 28B is a view that illustrates an example of CAD data for the machining product in FIG. 27;

FIG. 29A is a view that illustrate an example of change to a display screen in a case where a user selects a G code after selecting a machining shape; and

FIG. 29B is a view that illustrate an example of change to a display screen in a case where a user selects a G code after selecting a machining shape.

### PREFERRED MODE FOR CARRYING OUT THE INVENTION

### First Embodiment

Firstly, an outline of the present embodiment is described. In the present embodiment, a numerical control device stores associated information resulting from associating, in advance, tool information pertaining to a plurality of tools, shape identifiers indicating shapes that the plurality of tools can respectively machine, and at least one G code that can be used to machine a shape indicated by a shape identifier. The numerical control device acquires tool information pertaining to a tool selected for machining, uses the acquired tool information to query the associated information and thereby extract a shape identifier indicating a shape that can be machined by the tool having the acquired tool information, and displays the extracted shape that can be machined.

As a result, by virtue of the present embodiment, it is possible to solve the problem “narrow down G codes and/or machining shapes according to a selected tool so as to display the G codes and/or machining shapes”.

The above is an outline of the first embodiment.

Next, using the drawings, description is given in detail regarding a configuration according to the present embodiment.

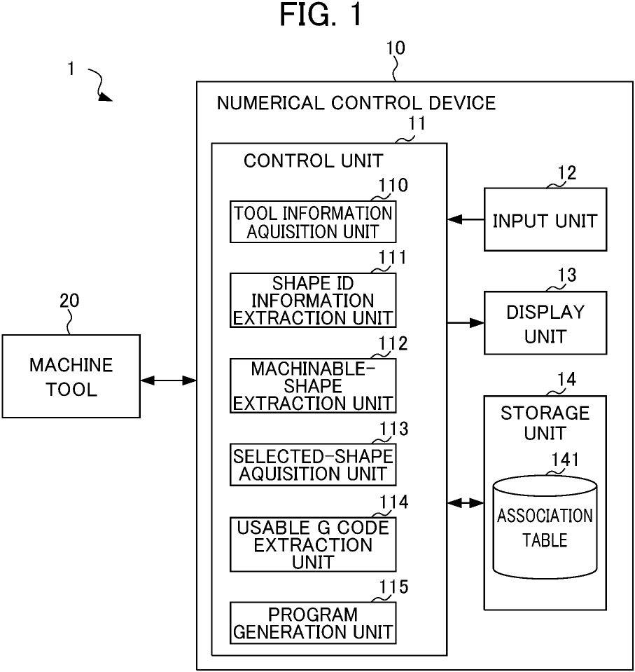

FIG. 1 is a functional block diagram illustrating an example of a functional configuration of a control system according to a first embodiment. As illustrated in FIG. 1, a control system 1 has a numerical control device 10 and a machine tool 20.

The numerical control device 10 and the machine tool 20 may be directly connected to each other via a connection interface (not shown). In addition, the numerical control device 10 and the machine tool 20 may be connected to each other via a network (not shown) such as a LAN (local area network) or the internet. In this case, it may be that the numerical control device 10 and the machine tool 20 are each provided with a communication unit (not shown) for communicating with each other via the corresponding connection. Note that, as described below, the machine tool 20 may include the numerical control device 10.

The machine tool 20 is a machine tool that is publicly known to a person skilled in the art, and operates based on an operation command from the numerical control device 10.

Note that, for example, the machine tool 20 may store a tool management table (not shown), which is for managing all tools that can be attached to the main shaft (not shown) of the machine tool 20, in a storage unit (not shown) such as an HDD (Hard Disk Drive) included in the machine tool 20. The later-described numerical control device 10 may acquire a tool name, tool diameter, tool length, etc. from the tool management table (not shown) in the machine tool 20 based on, inter alia, a tool number such as “T10” set in a machining program.

The numerical control device 10 is a numerical control device that is publicly known to a person skilled in the art, and generates an operation command based on execution of a machining program, and transmits the generated operation command to the machine tool 20. As a result, the numerical control device 10 controls operation by the machine tool 20.

As illustrated in FIG. 1, the numerical control device 10 includes a control unit 11, an input unit 12, a display unit 13, and a storage unit 14. The control unit 11 has a tool information acquisition unit 110, a shape ID information extraction unit 111, a machinable-shape extraction unit 112, a selected-shape acquisition unit 113, a usable G code extraction unit 114, and a program generation unit 115. In addition, the storage unit 14 includes an association table 141.

For example, the input unit 12 is configured by, inter alia, a keyboard, an MDI (Manual Data Input), and/or a touch panel disposed on the front surface of the later-described display unit 13, and accepts an input from a user who is an operator. Based on an input operation by the user, the input unit 12 functions as a shape selection acceptance unit for selecting a machinable shape extracted by the machinable-shape extraction unit 112, which is described below. In addition, the input unit 12, based on an input operation by the user, functions as a G code selection acceptance unit for selecting usable G codes which are further narrowed down by the usable G code extraction unit 114, which is described below.

The display unit 13 is a display device such as a liquid crystal display (LCD), and has a touch panel (not shown) disposed on a front surface of the display device. The display unit 13 functions as a machinable-shape display unit that displays a machinable shape extracted by the machinable-shape extraction unit 112 described below. In addition, the display unit 13 functions as a usable G code display unit for displaying usable G codes, which are further narrowed down by the usable G code extraction unit 114 described below and are for machining a machinable shape.

### Storage Unit 14

The storage unit 14 is, inter alia, a RAM (Random-Access Memory) or an HDD (Hard Disk Drive), for example. The storage unit 14 is provided with the association table 141 in addition to storing various programs including publicly known control software for the numerical control device 10 to function as a numerical control device.

The association table 141 includes associated information resulting from associating, in advance, tool information pertaining to a plurality of tools, shape identifiers (hereinafter, may be referred to as a “shape ID”) indicating shapes that the plurality of tools can respectively machine, and at least one G code that can be used to machine a shape indicated by a shape ID.

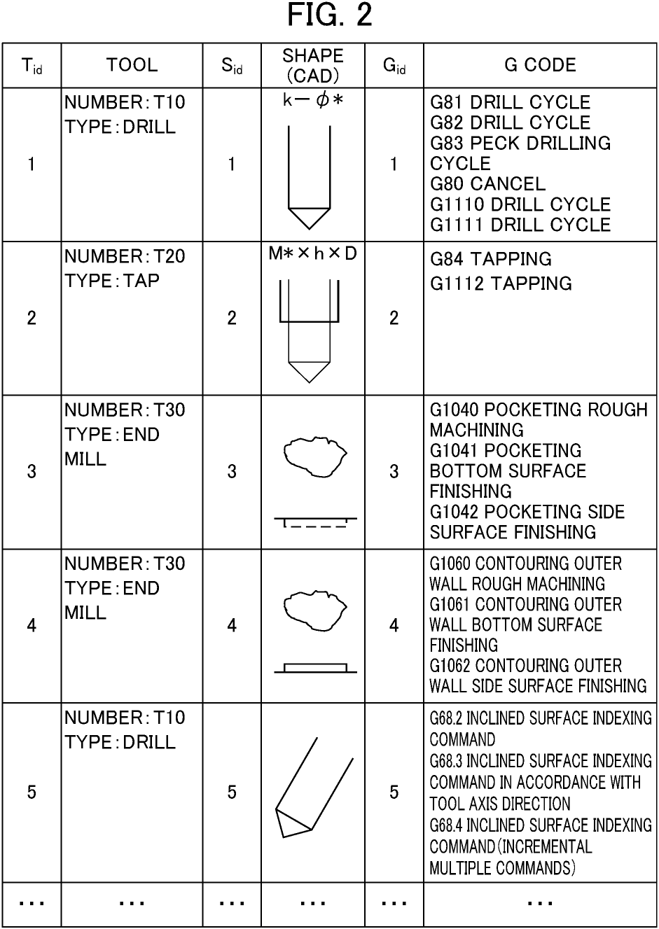

FIG. 2 illustrates an example of the association table 141.

As illustrated in FIG. 2, the association table 141 includes, for example, “T_{id}”, “Tool”, “S_{id}”, “Shape (CAD)”, “G_{id}” and “G code” storage regions.

The “T_{id}” storage region within the association table 141 stores a tool identifier (hereinafter, may be referred to as “tool ID”) such as “1” or “2” allocated for each tool in advance. Note that, regarding tool IDs stored in the “T_{id}” storage region, different tool IDs are allocated in a case where machined shaped differ even with a tool having the same tool number and type.

The “tool” storage region within the association table 141 stores a tool number (for example, “T10”, etc.) and a tool type (for example, “drill”, etc.), corresponding to “T_{id}”. Note that, as described above, it is desirable that the tool number and tool type stored in the “tool” storage region are acquired in advance from the tool management table (not shown) in the machine tool 20.

The “S_{id}” storage region within the association table 141 stores a shape ID such as “1” or “2” indicating a shape that can be machined by the tool stored in the “tool” storage region.

The “shape (CAD)” storage region within the association table 141 stores CAD data indicating a shape that is machined by the tool stored in the “tool” storage region. Specifically, the “shape (CAD)” storage region for which “S_{id}” is “1” stores CAD data indicating the shape of a hole opened by a drill having the tool number “T10”. In addition, the “shape (CAD)” storage region for which “S_{id}” is “2”, for example, stores CAD data indicating a shape for a screw thread portion that is indicated by a thick line and is machined by a tap having the tool number “T20” in a hole that is indicated by a fine line and is opened by a drill having the tool number “T10” or the like. In addition, the “shape (CAD)” storage region for which “S_{id}” is “3”, for example, stores CAD data indicating a shape that is pocketed by an end mill having the tool number “T30”. In addition, the “shape (CAD)” storage region for which “S_{id}” is “4”, for example, stores CAD data indicating a shape contoured by the end mill having the tool number “T30”. In addition, the “shape (CAD)” storage region for which “S_{id}” is “5”, for example, stores CAD data indicating a shape for a hole that is opened inclined obliquely by the drill having the tool number “T10”.

Note that the “shape (CAD)” storage region within the association table 141 is not limited to CAD data for a machined shape. For example, the “shape (CAD)” storage region for which “S_{id}” is “1”, for example, may store text data having a “k-ø*” format, such as “3-ø10” indicating a shape for three holes opened by a drill having a diameter of 10 mm and the tool number “T10”. Note that k indicates a number of holes and * indicates a hole diameter. In addition, the “shape (CAD)” storage region for which “S_{id}” is “2”, for example, may store text data having an “M*×h×D” format, such as “M10×1.5×15” indicating a shape for a screw thread portion having a height of 1.5 mm at a depth of 15 mm in a hole having a diameter of 10 mm, by a tap having the tool number “T20”. Note that h indicates the height of the screw thread and D indicates the depth of the screw thread portion.

The “G_{id}” storage region within the association table 141 stores a G code identifier (hereinafter, may be referred to as “G code ID”) such as “1” or “2” indicating a G code that can be used to machine the shape stored in the “shape (CAD)” storage region with the tool stored in the “tool” storage region.

The “G code” storage region within the association table 141 stores at least one G code that can be used to machine the shape stored in the “shape (CAD)” storage region with the tool stored in the “tool” storage region. Specifically, the “G code” storage region for which the G code ID “G_{id}” is “1” stores G codes - drill cycle “G81”, drill cycle “G82”, peck drilling cycle “G83”, cancel “G80”, drill cycle “G1110”, and drill cycle “G1111” - which can be used to machine a hole with the drill having the tool number “T10”. In addition, the “G code” storage region for which the G code ID “G_{id}” is “2” stores, for example, G codes - tapping “G84” and tapping “G1112” - which can be used to machine the shape for a screw thread with the tap having the tool number “T20”, in a hole opened by the drill having the tool number “T10”. In addition, the “G code” storage region for which the G code ID “G_{id}” is “3”, for example, stores G codes - pocketing rough machining “G1040”, pocketing bottom surface finishing “G1041”, and pocketing side surface finishing “G1042” - which can be used to perform pocketing with the end mill having the tool number “T30”. In addition, the “G code” storage region for which the G code ID “G_{id}” is “4”, for example, stores G codes -contouring outer wall rough machining “G1060”, contouring outer wall bottom surface finishing “G1061”, and contouring outer wall side surface finishing “G1062” - which can be used to perform contouring with the end mill having the tool number “T30”. In addition, the “G code” storage region for which the G code ID “G_{id}” is “5”, for example, stores G codes - inclined surface indexing command “G68.2”, inclined surface indexing command in accordance with a tool axis direction “G68.3”, and inclined surface indexing command (incremental multiple commands) “G68.4” - which can be used to machine a hole that is inclined obliquely with the drill having the tool number “T10”.

### Control Unit 11

The control unit 11 is something publicly known to a person skilled in the art that has a CPU (central processing unit), a ROM, a RAM, a CMOS (complementary metal-oxide-semiconductor) memory, etc., with each of these configured to be able to mutually communicate via a bus.

The CPU is a processor that performs overall control of the numerical control device 10. The CPU reads out, via the bus, a system program and an application program that are stored in the ROM, and controls the entirety of the numerical control device 10 in accordance with a system program and the application program. As a result, as illustrated in FIG. 1, the control unit 11 is configured to realize functionality for the tool information acquisition unit 110, the shape ID information extraction unit 111, the machinable-shape extraction unit 112, the selected-shape acquisition unit 113, the usable G code extraction unit 114, and the program generation unit 115. Various data such as temporary calculation data or display data is stored in the RAM. In addition, the CMOS memory is supported by a battery (not shown), and is configured as a non-volatile memory for which a storage state is held even if a power supply for the numerical control device 10 is turned off.

The tool information acquisition unit 110 acquires tool information pertaining to a tool selected for machining.

Specifically, the tool information acquisition unit 110 acquires tool information (for example, a tool number, tool type, etc.) based on an input operation by a user via the input unit 12, for example. Note that, in a case where tool information is not inputted by a user via the input unit 12, it may be that, for example, the tool information acquisition unit 110 acquires tool information (for example, a tool number, tool type, etc.) from tooling data acquired in advance from the tool management data (not shown) in the machine tool 20.

The shape ID information extraction unit 111 uses the tool information acquired by the tool information acquisition unit 110 to query the association table 141, which is an associated information storage unit, and thereby extract a shape ID (Sid) indicating shapes that can be machined by the tool corresponding to the acquired tool information.

Specifically, for example in a case where the tool information acquired by the tool information acquisition unit 110 includes the tool number “T10”, the shape ID information extraction unit 111 extracts the shape IDs for which “S_{id}” is “1” and “5” based on the association table 141. In addition, for example in a case where the tool information acquired by the tool information acquisition unit 110 includes the tool number “T20”, the shape ID information extraction unit 111 extracts the shape ID for which “S_{id}” is “2” based on the association table 141. In addition, for example in a case where the tool information acquired by the tool information acquisition unit 110 includes the tool number “T30”, the shape ID information extraction unit 111 extracts shape IDs for which “S_{id}” is “3” and “4” based on the association table 141.

Based on a shape ID extracted by the shape ID information extraction unit 111, the machinable-shape extraction unit 112 extracts machinable shapes from CAD data for a machining product to be achieved.

Specifically, for example, in a case where shape IDs extracted by the shape ID information extraction unit 111 are “1” and “5”, the machinable-shape extraction unit 112 extracts from the CAD data a hole machined parallel to an X axis, Y axis, or Z axis and a hole machined inclined obliquely, as machinable shapes. In addition, in a case where the shape ID extracted by the shape ID information extraction unit 111 is “2”, the machinable-shape extraction unit 112 extracts from the CAD data a portion at which a screw thread is machined, as a machinable shape. In addition, in a case where the shape IDs extracted by the shape ID information extraction unit 111 is “3” and “4”, the machinable-shape extraction unit 112 extracts from the CAD data a portion at which pocketing is performed and a portion at which contouring is performed, as machinable shapes. Note that a detailed description for the machinable-shape extraction unit 112 is given below.

The display unit 13 which serves as a machinable-shape display unit displays machinable shapes extracted by the machinable-shape extraction unit 112.

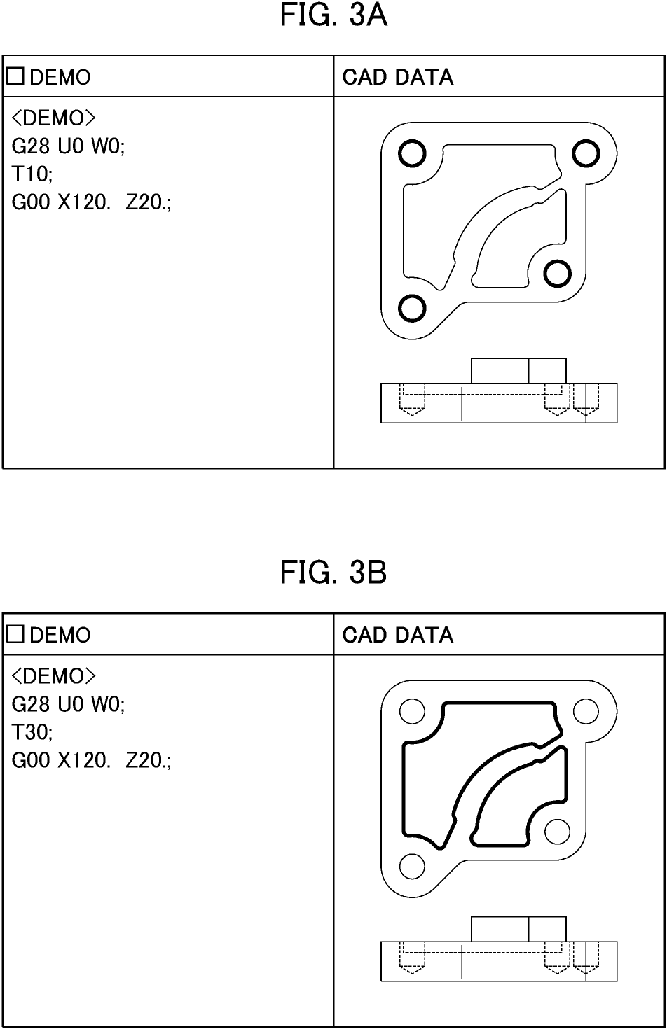

FIG. 3A and FIG. 3B are views that illustrate an example of a display screen for extracted machinable shapes.

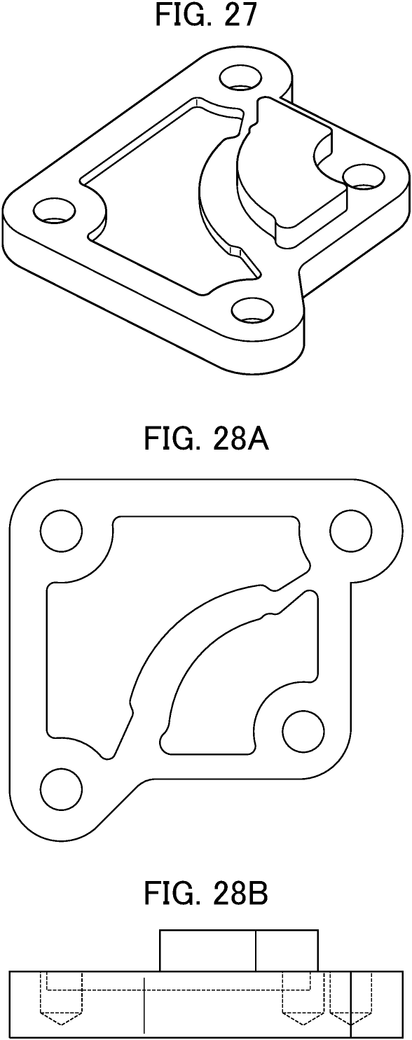

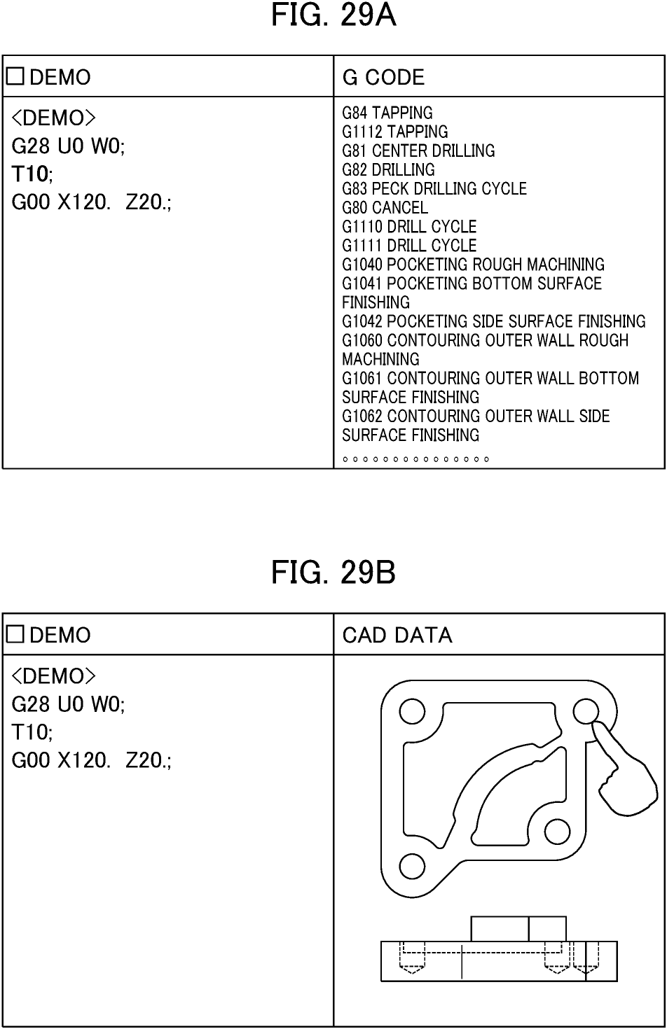

As illustrated in FIG. 3A, in a case where the hole shape having the shape ID “1” is extracted from the CAD data illustrated in FIG. 28A and FIG. 28B as a shape that the machinable-shape extraction unit 112 can machine, it may be that, for example, the display unit 13 which serves as a machinable-shape display unit displays the extracted hole shape emphasized by a thick line. In addition, as illustrated in FIG. 3B, in a case where the machining shapes for a portion that is to be pocketed and has the shape ID “3” and/or a portion that is to be contoured and has the shape ID “4” are extracted from the CAD data illustrated in FIG. 28A and FIG. 28B as shapes that the machinable-shape extraction unit 112 can machine, it may be that, for example, the display unit 13 which serves as a machinable-shape display unit displays the extracted machinable shapes emphasized by thick lines.

Note that the display unit 13 which serves as a machinable-shape display unit has displayed an extracted machinable shape emphasized by a thick line, but an emphasized display may be performed by a line other than a thick line, or an emphasized display may be performed by a line having a color such as red.

For example, in a case where a user has, in a display screen from FIG. 3A or FIG. 3B displayed on the display unit 13 which serves as a machinable-shape display unit, selected a machinable shape via the input unit 12 which serves as a shape selection acceptance unit, the selected-shape acquisition unit 113 acquires a shape ID for the selected machinable shape. The selected-shape acquisition unit 113 outputs the acquired shape ID for the machinable shape together with the tool information acquired by the tool information acquisition unit 110 to the usable G code extraction unit 114, which is described below.

The usable G code extraction unit 114 uses the tool information and shape ID for the machinable shape, which are received from the selected-shape acquisition unit 113, to query the association table 141 which serves as an associated information storage unit and uses the tool corresponding to the received tool information to further narrow down G codes that can be used to machine the shape corresponding to the received shape ID.

Specifically, for example, in a case of receiving from the selected-shape acquisition unit 113 the tool number “T10” acquired by the tool information acquisition unit 110 and the shape ID “1” indicating the hole shape selected by the user via the input unit 12 which serves as a shape selection acceptance unit, based on the association table 141, the usable G code extraction unit 114 extracts and narrows down usable G codes - drill cycle “G81”, drill cycle “G82”, peck drilling cycle “G83”, cancel “G80”, drill cycle “G1110”, and drill cycle “G1111” - for which the G code ID “G_{id}” is “1”. In addition, in a case of receiving from the selected-shape acquisition unit 113 the tool number “T20” acquired by the tool information acquisition unit 110 and the shape ID “2” indicating a screw thread portion selected by the user via the input unit 12 which serves as a shape selection acceptance unit, based on the association table 141, the usable G code extraction unit 114 extracts and narrows down usable G codes -tapping “G84” and tapping “G1112” - for which the G code ID “G_{id}” is “2”.

In addition, in a case of receiving from the selected-shape acquisition unit 113 the tool number “T30” acquired by the tool information acquisition unit 110 and the shape ID “3” indicating a pocketing portion selected by the user via the input unit 12 which serves as a shape selection acceptance unit, based on the association table 141, the usable G code extraction unit 114 extracts and narrows down usable G codes -pocketing rough machining “G1040”, pocketing bottom surface finishing “G1041”, and pocketing side surface finishing “G1042” - for which the G code ID “G_{id}” is “3”. In addition, in a case of receiving from the selected-shape acquisition unit 113 the tool number “T30” acquired by the tool information acquisition unit 110 and the shape ID “4” indicating a contouring portion selected by the user via the input unit 12 which serves as a shape selection acceptance unit, based on the association table 141, the usable G code extraction unit 114 extracts and narrows down usable G codes -contouring outer wall rough machining “G1060”, contouring outer wall bottom surface finishing “G1061”, and contouring outer wall side surface finishing “G1062” - for which the G code ID “G_{id}” is “4”. In addition, in a case of receiving from the selected-shape acquisition unit 113 the tool number “T10” acquired by the tool information acquisition unit 110 and the shape ID “5” indicating an obliquely inclined hole shape selected by the user via the input unit 12 which serves as a shape selection acceptance unit, based on the association table 141, the usable G code extraction unit 114 extracts and narrows down usable G codes - inclined surface indexing command “G68.2”, inclined surface indexing command in accordance with a tool axis direction “G68.3”, and inclined surface indexing command (incremental multiple commands) “G68.4” - for which the G code ID “G_{id}” is “5”.

The display unit 13 which serves as a usable G code display unit displays the usable G codes that were narrowed down by the usable G code extraction unit 114.

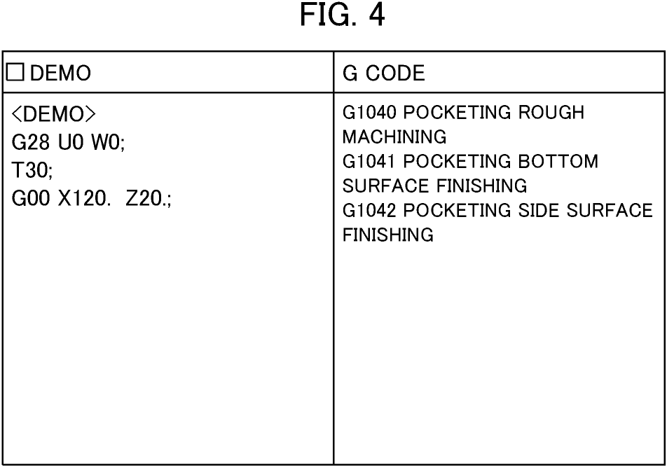

FIG. 4 is a view that illustrates an example of a display screen for display of usable G codes that have been narrowed down.

For example, in a case where a pocketing portion is selected by a user in the display screen illustrated in FIG. 3B, as illustrated in FIG. 4, the display unit 13 which serves as a usable G code display unit displays only G codes which are pocketing rough machining “G1040”, pocketing bottom surface finishing “G1041”, and pocketing side surface finishing “G1042”.

As a result, the numerical control device 10 enables selection of a G code and a machining shape to be easily performed, and can shorten an amount of time for creating a machining program. In addition, the numerical control device 10 presents available G codes and machining shapes and allows a user to make a selection, whereby it is possible to prevent a machining program from being erroneously inputted.

For example, the program generation unit 115 accepts a G code selected by a user, via the input unit 12 which serves as a G code selection acceptance unit, on the screen in FIG. 4 displayed on the display unit 13 which serves as a usable G code display unit. The program generation unit 115 displays a parameter setting screen on the display unit 13 in order for parameters for the selected G code to be set.

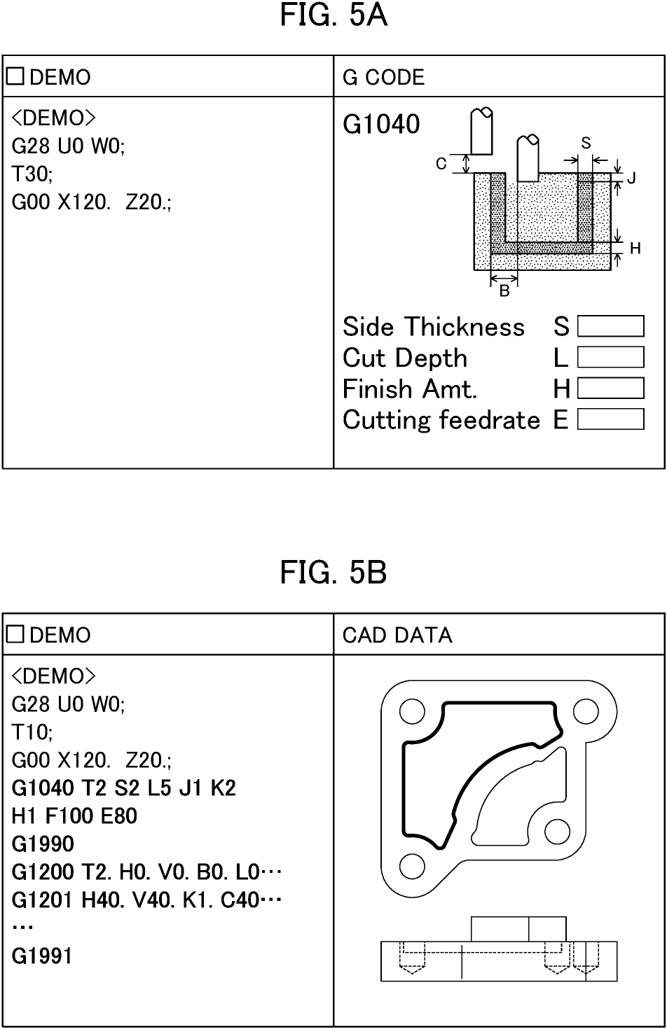

FIG. 5A is a view that illustrates an example of a setting screen for a selected G code. FIG. 5B is a view that illustrates an example of display screen in which a block for the selected G code has been added.

The program generation unit 115 uses a parameter inputted by a user via the setting screen in FIG. 5A to generate machining program by adding a block that includes the selected G code, as illustrated in FIG. 5B.

Note that “G1200” is a G code for setting a start point for pocketing, and “G1201” is a G code for setting a straight line in pocketing. In addition, “G1990” is a G code for a group range selection start command, and “G1991” is a G code for a group range selection end command.

### Machining Program Generation Process by Numerical Control Device 10

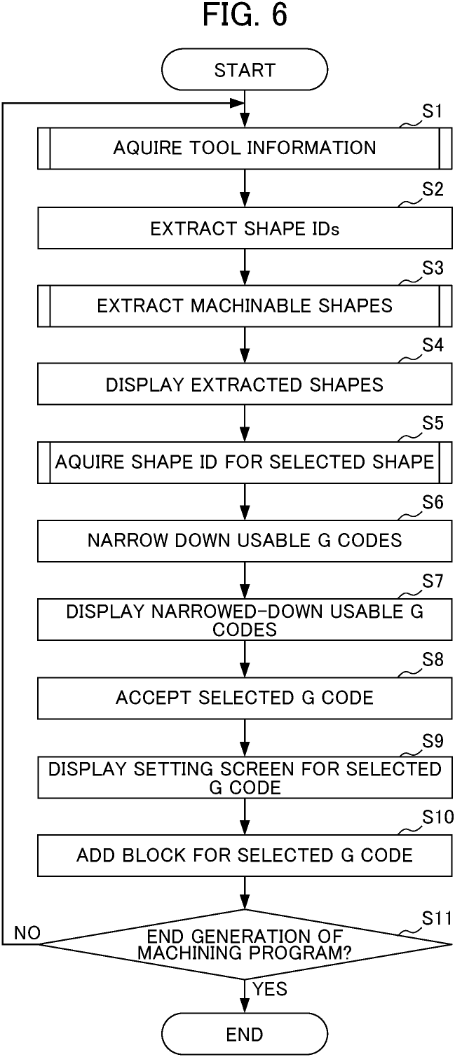

Next, with reference to FIG. 6, a flow for a machining program generation process by the numerical control device 10 is described.

FIG. 6 is a flow chart for describing a machining program generation process by the numerical control device 10. The flow illustrated here is executed each time a machining program is generated.

Description is given below regarding a case in which a hole shape (hereinafter, may be referred to as “hole shape”), a screw thread portion (hereinafter, may be referred to as “screw shape”), a pocketing portion (hereinafter, may be referred to as “pocket shape”), a contouring portion (hereinafter, may be referred to as “contour shape”), and an obliquely inclined hole shape (hereinafter, may be referred to as “inclined shape”) are machinable shapes, but there is no limitation to this. It is possible to similarly perform processing even for a case for a machinable shape other than a hole shape, a screw shape, a pocket shape, a contour shape, and an inclined shape.

In Step S1, the tool information acquisition unit 110, based on an input operation by a user via the input unit 12, performs a tool information acquisition process to acquire tool information (for example, a tool number, tool type, etc.). Note that a detailed flow for the tool information acquisition process is described below.

In Step S2, the shape ID information extraction unit 111 uses the tool information acquired in Step S1 to query the association table 141, which is an associated information storage unit, and thereby extract shape IDs indicating shapes that can be machined by the tool corresponding to the acquired tool information.

In Step S3, based on the shape IDs extracted in Step S2, the machinable-shape extraction unit 112 performs a machinable-shape extraction process and extracts machinable shapes from CAD data for a machining product to be achieved. Note that a detailed flow for the machinable-shape extraction process is given below.

In Step S4, the display unit 13 which serves as a machinable-shape display unit displays (for example, FIG. 3A or FIG. 3B) the shapes extracted in Step S3.

In Step S5, based on the selection of a machinable shape by a user via the input unit 12 which serves as a shape selection acceptance unit in the screen displayed by the display unit 13 which serves as a machinable-shape display unit, the selected-shape acquisition unit 113 performs a selected shape acquisition process and acquires a shape ID for the machinable shape selected by the user. Note that a detailed flow for the selected shape acquisition process is described below.

In Step S6, the usable G code extraction unit 114 uses the tool information acquired in Step S1 and the shape ID for the machinable shape selected in Step S5 to query the association table 141 and further narrow down usable G codes.

In Step S7, the display unit 13 which serves as a usable G code display unit displays (for example, FIG. 4) the usable G codes which were narrowed down in Step S6.

In Step S8, the program generation unit 115 accepts a G code selected by a user, via the input unit 12 which serves as a G code selection acceptance unit, on a display screen displayed on the display unit 13 which serves as a usable G code display unit.

In Step S9, the program generation unit 115 displays a setting screen (for example, FIG. 5A) for the G code accepted in Step S8 on the display unit 13, and accepts a parameter inputted by the user via the input unit 12.

In Step S10, the program generation unit 115 uses the parameter inputted by the user in Step S9 to add (for example, FIG. 5B) a block that includes the selected G code.

In Step S11, the program generation unit 115 determines whether generation of the machining program has ended. In a case where an input such as “save” or “end” for the machining program is accepted from a user via the input unit 12, the program generation unit 115 determines that generation of the machining program has ended, and ends the processing. In contrast, in a case where an input such as “save” or “end” for the machining program is not accepted from a user via the input unit 12, the program generation unit 115 determines that generation of the machining program has not ended, and returns the processing to Step S1.

### Tool Information Acquisition Process in Step S1

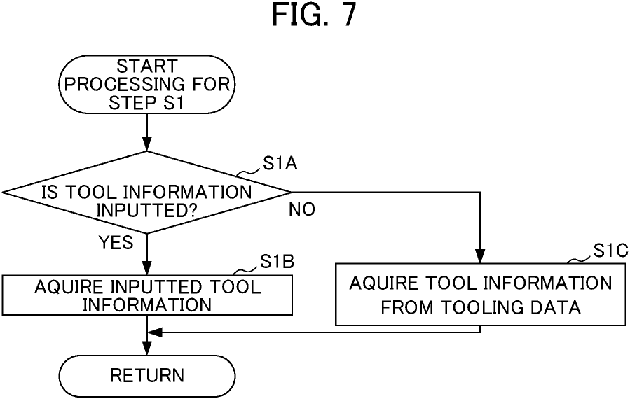

FIG. 7 is a flow chart for describing the tool information acquisition process described in Step S1 in FIG. 6.

In Step S1A, based on an input operation by the user via the input unit 12, the tool information acquisition unit 110 determines whether tool information has been inputted. In a case where tool information is inputted, the process proceeds to Step S1B. In contrast, in a case where tool information is not inputted, the process proceeds to Step S1C.

In Step S1B, the tool information acquisition unit 110 acquires tool information (for example, a tool number, tool type, etc.) inputted by the user via the input unit 12.

In Step S1C, the tool information acquisition unit 110 acquires tool information (for example, a tool number, tool type, etc.) from tooling data acquired in advance from the tool management data (not shown) in the machine tool 20.

By the above, the flow for the tool information acquisition process ends, and the process returns to the flow in FIG. 6.

### Machinable-Shape Extraction Process in Step S3

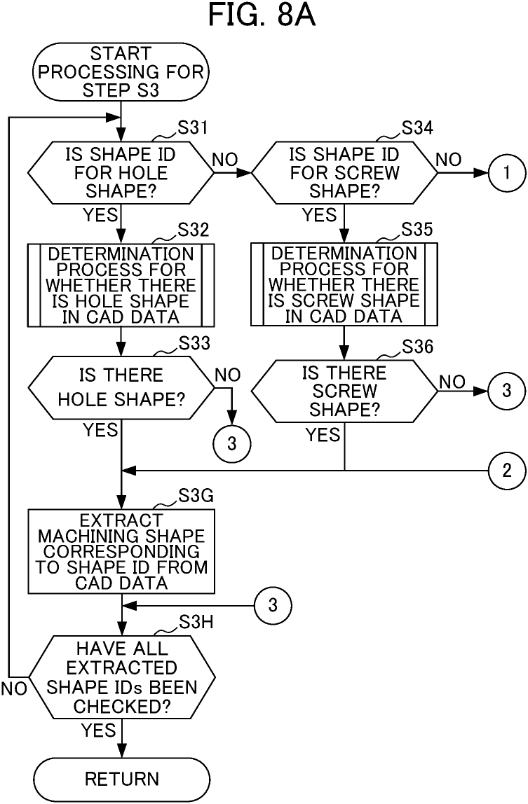

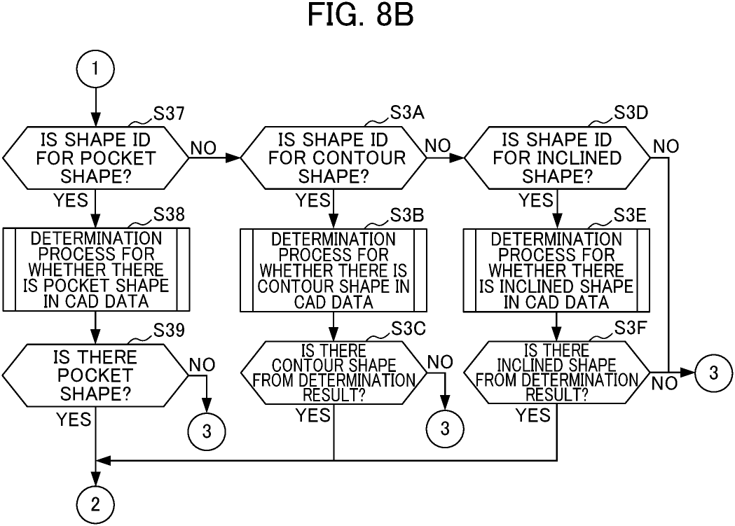

FIG. 8A and FIG. 8B are flow charts for describing the machinable-shape extraction process described in Step S3 in FIG. 6.

In Step S31, the machinable-shape extraction unit 112 determines whether the shape ID extracted in Step S2 is “1” for a hole shape. In a case where the shape ID is “1” for a hole shape, the process proceeds to Step S32. In contrast, in a case where the shape ID is not “1” for a hole shape, the process proceeds to Step S34.

In Step S32, the machinable-shape extraction unit 112 performs a determination process regarding whether there is a hole shape having the shape ID “1” in the CAD data for the machining product. Note that a detailed flow for the determination process in Step S32 is described below.

In Step S33, in a case where the result of the determination process in Step S32 is that there is a hole shape, the process proceeds to Step S3G. In contrast, in a case where the result of the determination process in Step S32 is that there is no hole shape, the process proceeds to Step S3H.

In Step S34, the machinable-shape extraction unit 112 determines whether the shape ID extracted in Step S2 is “2” for a screw shape. In a case where the shape ID is “2” for a screw shape, the process proceeds to Step S35. In contrast, in a case where the shape ID is not “2” for a screw shape, the process proceeds to Step S37 in FIG. 8B.

In Step S35, the machinable-shape extraction unit 112 performs a determination process regarding whether there is a screw shape having the shape ID “2” in the CAD data for the machining product. Note that a detailed flow for the determination process in Step S35 is described below.

In Step S36, in a case where the result of the determination process in Step S35 is that there is a screw shape, the process proceeds to Step S3G. In contrast, in a case where the result of the determination process in Step S35 is that there is no screw shape, the process proceeds to Step S3H.

In Step S37 in FIG. 8B, the machinable-shape extraction unit 112 determines whether the shape ID extracted in Step S2 is “3” for a pocket shape. In a case where the shape ID is “3” for a pocket shape, the process proceeds to Step S38. In contrast, in a case where the shape ID is not “3” for a pocket shape, the process proceeds to Step S3A.

In Step S38, the machinable-shape extraction unit 112 performs a determination process regarding whether there is a pocket shape having the shape ID “3” in the CAD data for the machining product. Note that a detailed flow for the determination process in Step S38 is described below.

In Step S39, in a case where the result of the determination process in Step S38 is that there is a pocket shape, the process proceeds to Step S3G. In contrast, in a case where the result of the determination process in Step S38 is that there is no pocket shape, the process proceeds to Step S3H in FIG. 8A.

In Step S3A, the machinable-shape extraction unit 112 determines whether the shape ID extracted in Step S2 is “4” for a contour shape. In a case where the shape ID is “4” for a contour shape, the process proceeds to Step S3B. In contrast, in a case where the shape ID is not “4” for a contour shape, the process proceeds to Step S3D.

In Step S3B, the machinable-shape extraction unit 112 performs a determination process regarding whether there is a contour shape having the shape ID “4” in the CAD data for the machining product. Note that a detailed flow for the determination process in Step S3B is described below.

In Step S3C, in a case where the result of the determination process in Step S3B is that there is a contour shape, the machinable-shape extraction unit 112 advances the process to Step S3G in FIG. 8A. In contrast, in a case where the result of the determination process in Step S3G is that there is no contour shape, the machinable-shape extraction unit 112 advances the process to Step S3H in FIG. 8A.

In Step S3D, the machinable-shape extraction unit 112 determines whether the shape ID extracted in Step S2 is “5” for an inclined shape. In a case where the shape ID is “5” for an inclined shape, the process proceeds to Step S3E. In contrast, in a case where the shape ID is not “5” for a contour shape, the process proceeds to Step S3H in FIG. 8A.

In Step S3E, the machinable-shape extraction unit 112 performs a determination process regarding whether there is an inclined shape having the shape ID “5” in the CAD data for the machining product. Note that a detailed flow for the determination process in Step S3E is described below.

In Step S3F, in a case where the result of the determination process in Step S3E is that there is an inclined shape, the process proceeds to Step S3G in FIG. 8A. In contrast, in a case where the result of the determination process in Step S3E is that there is no inclined shape, the process proceeds to Step S3H in FIG. 8A.

In Step S3G, the machinable-shape extraction unit 112 extracts, from the CAD data, a machinable shape corresponding to the shape ID. The process then proceeds to Step S3H.

In Step S3H, the machinable-shape extraction unit 112 determines whether all extracted shape IDs have been checked. In a case where all extracted shape IDs have not been checked, the process returns to Step S31. In contrast, in a case where all extracted shape IDs have been checked, the flow for the machinable-shape extraction process in Step S3 ends and the process returns to the flow in FIG. 6.

### Selected Shape Acquisition Process in Step S5

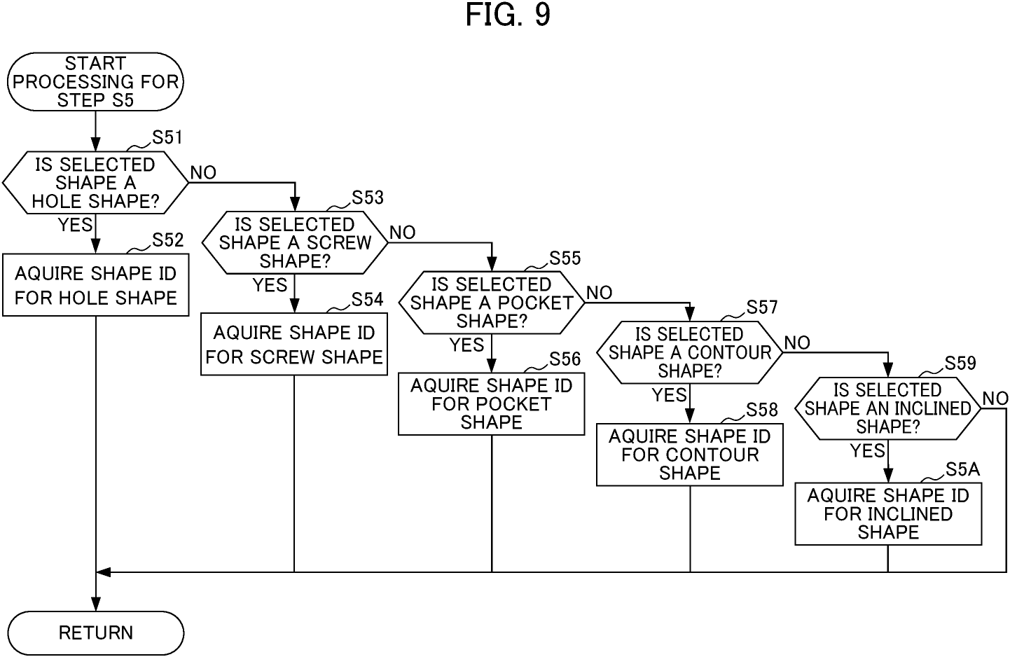

FIG. 9 is a flow chart for describing the selected shape acquisition process described in Step S5 in FIG. 6.

In Step S51, the selected-shape acquisition unit 113 determines whether the machining shape selected by the user is a hole shape. In a case where the machining shape selected by the user is a hole shape, the process proceeds to Step S52. In contrast, in a case where the machining shape selected by the user is not a hole shape, the process proceeds to Step S53.

In Step S52, the selected-shape acquisition unit 113 acquires the shape ID “1” for the hole shape selected by the user.

In Step S53, the selected-shape acquisition unit 113 determines whether the machining shape selected by the user is a screw shape. In a case where the machining shape selected by the user is a screw shape, the process proceeds to Step S54. In contrast, in a case where the machining shape selected by the user is a not screw shape, the process proceeds to Step S55.

In Step S54, the selected-shape acquisition unit 113 acquires the shape ID “2” for the screw shape selected by the user.

In Step S55, the selected-shape acquisition unit 113 determines whether the machining shape selected by the user is a pocket shape. In a case where the machining shape selected by the user is a pocket shape, the process proceeds to Step S56. In contrast, in a case where the machining shape selected by the user is not a pocket shape, the process proceeds to Step S57.

In Step S56, the selected-shape acquisition unit 113 acquires the shape ID “3” for the pocket shape selected by the user.

In Step S57, the selected-shape acquisition unit 113 determines whether the machining shape selected by the user is a contour shape. In a case where the machining shape selected by the user is a contour shape, the process proceeds to Step S58. In contrast, in a case where the machining shape selected by the user is not a contour shape, the process proceeds to Step S59.

In Step S58, the selected-shape acquisition unit 113 acquires the shape ID “4” for the contour shape selected by the user.

In Step S59, the selected-shape acquisition unit 113 determines whether the machining shape selected by the user is an inclined shape. In a case where the machining shape selected by the user is an inclined shape, the process proceeds to Step S5A. In contrast, in a case where the machining shape selected by the user is not an inclined shape, the flow for the selected shape acquisition process ends, and the process returns to the flow in FIG. 6.

In Step S5A, with the machining shape selected by the user being an inclined shape, the selected-shape acquisition unit 113 acquires the shape ID “5” for the inclined shape. By the above, the flow for the selected shape acquisition process ends, and the process returns to the flow in FIG. 6.

### Determination Process in Step S32

FIG. 10 is a flow chart for describing the determination process in Step S32 in FIG. 8A regarding whether a hole shape having the shape ID “1” is present in CAD data for the machining product.

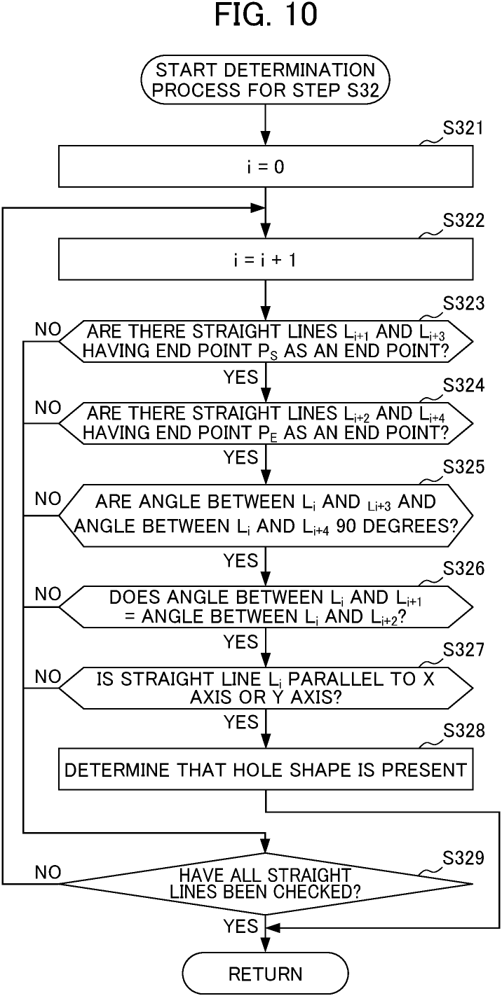

FIG. 11 is a view that illustrates an example of CAD data for a hole shape. As illustrated in FIG. 11, let the distance (hole diameter) between an end point Pₛ and an end point P_{E} be Lᵢ, let the distance between the end point Pₛ and the tip of the hole shape be Lᵢ₊₁, let the distance between the end point P_{E} and the tip of the hole shape be Lᵢ₊₂, let the distance between the end point Pₛ and a terminal end of the hole shape be Lᵢ₊₃, and let the distance from the end point P_{E} to a terminal end of the hole shape be Lᵢ₊₄. In addition, an angle between the straight line Lᵢ and the straight line Lᵢ₊ₛ and an angle between the straight line Lᵢ and the straight line Lᵢ₊ₜ are 90 degrees. In addition, a triangle formed from the straight lines Lᵢ, Lᵢ₊₁, and Lᵢ₊₂ is an isosceles triangle, with the angle between the straight line Lᵢ and the straight line Lᵢ₊₁ being the same as the angle between the straight line Lᵢ and the straight line Lᵢ₊₂.

In Step S321, the machinable-shape extraction unit 112 initializes i to “0”.

In Step S322, the machinable-shape extraction unit 112 increases i by 1.

In Step S323, the machinable-shape extraction unit 112 determines whether there are straight lines Lᵢ₊₁ and Lᵢ₊₃ having the end point Pₛ as end points in the CAD data for the machining product. In a case where the straight lines Lᵢ₊₁ and Lᵢ₊₃ are present, the process proceeds to Step S324. In contrast, in a case where the straight lines Lᵢ₊₁ and Lᵢ₊₃ are not present, the process proceeds to Step S329.

In Step S324, the machinable-shape extraction unit 112 determines whether straight lines Lᵢ₊₂ and Lᵢ₊₄ having the end point P_{E} as end points are present in the CAD data for the machining product. In a case where the straight lines Lᵢ₊₂ and Lᵢ₊₄ are present, the process proceeds to Step S325. In contrast, in a case where the straight lines Lᵢ₊₂ and Lᵢ₊₄ are not present, the process proceeds to Step S329.

In Step S325, the machinable-shape extraction unit 112 determines whether the angle between the straight line Lᵢ and the straight line Lᵢ₊₃ and the angle between the straight line Lᵢ and the straight line Lᵢ₊₄ are 90 degrees. In a case where the angle between the straight line Lᵢ and the straight line Lᵢ₊₃ and the angle between the straight line Lᵢ and the straight line Lᵢ₊₄ are 90 degrees, the process proceeds to Step S326. In a case where the angle between the straight line Lᵢ and the straight line Lᵢ₊₃ and/or the angle between the straight line Lᵢ and the straight line Lᵢ₊₄ is not 90 degrees, the process proceeds to Step S329.

In Step S326, the machinable-shape extraction unit 112 determines whether the angle between the straight line Lᵢ and the straight line Lᵢ₊₁ is the same as the angle between the straight line Lᵢ and the straight line Lᵢ₊₂. In a case where the angle between the straight line Lᵢ and the straight line Lᵢ₊₁ is equal to the angle between the straight line Lᵢ and the straight line Lᵢ₊₂, the process proceeds to Step S327. In contrast, in a case where the angle between the straight line Lᵢ and the straight line Lᵢ₊₁ is not equal to the angle between the straight line Lᵢ and the straight line Lᵢ₊₂, the process proceeds to Step S329.

In Step S327, the machinable-shape extraction unit 112 determines whether the straight line Lᵢ is parallel to the X axis or the Y axis. In a case where the straight line Lᵢ is parallel to the X axis or the Y axis, the process proceeds to Step S328. In contrast, in a case where the straight line Lᵢ is not parallel to the X axis and not parallel to the Y axis, the process proceeds to Step S329.

In Step S328, the machinable-shape extraction unit 112 determines that there is a hole shape in the CAD data for the machining product. The flow for the determination process in Step S32 ends, and the process returns to the flow in FIG. 8A.

In Step S329, the machinable-shape extraction unit 112 determines whether all straight lines have been checked. In a case where all straight lines have been checked, the flow for the determination process in Step S32 ends, and the process returns to the flow in FIG. 8A. In contrast, in a case where not all straight lines have been checked, the process returns to Step S322.

### Determination Process in Step S35

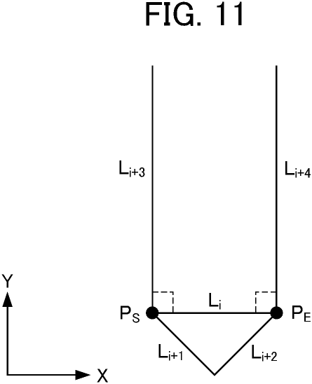

FIG. 12 is a flow chart for describing the determination process in Step S35 in FIG. 8A regarding whether a screw shape having the shape ID “2” is present in CAD data for the machining product.

Note that processing in Step S351, Step S352, and Step S359 is similar to processing in Step S321, Step S322, and Step S329 in FIG. 10, and description thereof is omitted.

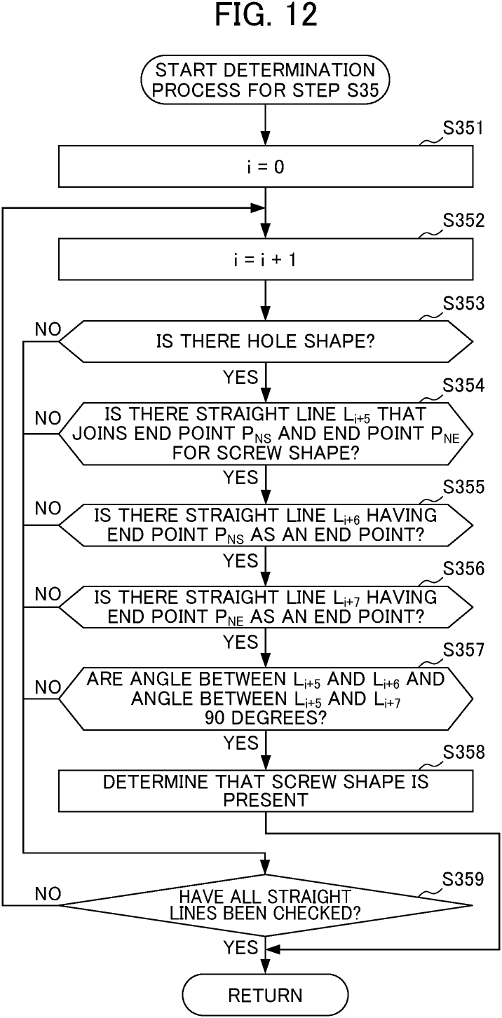

In addition, FIG. 13 is a view that illustrates an example of CAD data for a screw shape. The screw shape in FIG. 13 includes a hole shape that is similar to that in FIG. 11. Accordingly, description of the hole shape is omitted. As illustrated in FIG. 13, formed on the hole shape in FIG. 11 is a screw shape, for which the distance between an end point P_{NS} and an end point P_{NE} is made to be Lᵢ₊₅, the distance between the end point P_{NS} and a terminal end for the screw shape is made to be Lᵢ₊₆, and the distance between the end point P_{NE} and a terminal end of the screw shape is made to be Lᵢ₊₇.

In Step S353, the machinable-shape extraction unit 112 performs a similar determination process to that in FIG. 10 to thereby determine whether there is a hole shape in the CAD data for the machining product. In a case where there is a hole shape, the process proceeds to Step S354. In contrast, in a case where there is no hole shape, the process proceeds to Step S359.

In Step S354, the machinable-shape extraction unit 112 determine whether there is a straight line Lᵢ₊₅ joining the end point P_{NS} and the end point P_{NE} in the CAD data for the hole shape for which the determination process was performed in Step S353. In a case where the straight line Lᵢ₊ₛ is present, the process proceeds to Step S355. In contrast, in a case where the straight line Lᵢ₊₅ is not present, the process proceeds to Step S359.

In Step S355, the machinable-shape extraction unit 112 determines whether the straight line Lᵢ₊₆ having the end point P_{NS} as an end point is present in the CAD data for the machining product. In a case where the straight line Lᵢ₊₆ is present, the process proceeds to Step S356. In contrast, in a case where the straight line Lᵢ₊₆ is not present, the process proceeds to Step S359.

In Step S356, the machinable-shape extraction unit 112 determines whether the straight line Lᵢ₊₇ having the end point P_{NE} as an end point is present in the CAD data for the machining product. In a case where the straight line Lᵢ₊₇ is present, the process proceeds to Step S357. In contrast, in a case where the straight line Lᵢ₊₇ is not present, the process proceeds to Step S359.

In Step S357, the machinable-shape extraction unit 112 determines whether the angle between the straight line Lᵢ₊₅ and the straight line Lᵢ₊₆ and the angle between the straight line L₁₊₅ and the straight line Lᵢ₊₇ are 90 degrees. In a case where the angle between the straight line Lᵢ₊ₛ and the straight line Lᵢ₊₆ and the angle between the straight line L₁₊₅ and the straight line Lᵢ₊₇ are 90 degrees, the process proceeds to Step S358. In a case where the angle between the straight line L₁₊₅ and the straight line Lᵢ₊₆ and/or the angle between the straight line Lᵢ₊₅ and the straight line Lᵢ₊₇ is not 90 degrees, the process proceeds to Step S359.

In Step S358, the machinable-shape extraction unit 112 determines that there is a screw shape in the CAD data for the machining product. The flow for the determination process in Step S35 ends, and the process returns to the flow in FIG. 8A.

### Determination Process in Step S38

FIG. 14 is a flow chart for describing the determination process in Step S38 in FIG. 8A regarding whether a pocket shape having the shape ID “3” is present in CAD data for the machining product.

Note that processing in Step S381, Step S382, and Step S38A is similar to processing in Step S321, Step S322, and Step S329 in FIG. 10, and description thereof is omitted.

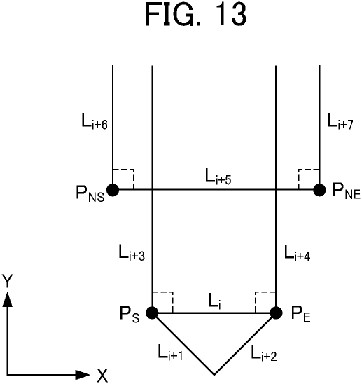

In addition, FIG. 15 is a view that illustrates an example of CAD data for a pocket shape. The upper part in FIG. 15 illustrates a pocket shape seen from above, and the lower part in FIG. 15 illustrates the pocket shape seen from in front. As illustrated in FIG. 15, let a straight line that joins an end point P_{SL} with an end point P_{SR} in the X axis direction be L_{LR}.

In Step S383, the machinable-shape extraction unit 112 acquires an element Eⱼ adjacent to any one element in the CAD data for the machining product (j is an integer from 1 to n, and n is an integer that is equal to or greater than 1).

In Step S384, the machinable-shape extraction unit 112 acquires a leftmost end point P_{L} and a rightmost end point P_{R} belonging to the shape in the X axis direction from the element Eⱼ.

In Step S385, from all straight-line elements, the machinable-shape extraction unit 112 searches for straight lines L_{L} and L_{R} that are parallel to the Y axis and for which a Y-axis value (Y value) for a start point or terminal point thereof is the same as the Y-axis value (Y value) for the point P_{L} or point P_{R} acquired in Step S384.

In Step S386, the machinable-shape extraction unit 112 determines whether the straight lines L_{L} and L_{R} are present. In a case where the straight lines L_{L} and L_{R} are present, the process proceeds to Step S387. In contrast, in a case where the straight lines L_{L} and L_{R} are not present, the process proceeds to Step S38A.

In Step S387, the machinable-shape extraction unit 112 determines whether there is a straight line L_{LR} that joins the end point P_{SL}, which has a low Y value and belongs to the straight line L_{L}, with the end point P_{SR}, which has a low Y value and belongs to the straight line L_{R}. In a case where the straight line L_{LR} is present, the process proceeds to Step S388. In contrast, in a case where the straight line L_{LR} is not present, the process proceeds to Step S38A.

In Step S388, the machinable-shape extraction unit 112 determines whether there is no other element that passes through the end points P_{SL}, P_{SR}. In a case where there is no other element that passes through the end points P_{SL}, P_{SR}, the process proceeds to Step S389. In contrast, in a case where there is another element that passes through the end points P_{SL}, P_{SR}, the process proceeds to Step S38A.

In Step S389, the machinable-shape extraction unit 112 determines that there is a pocket shape in the CAD data for the machining product. The flow for the determination process in Step S38 ends, and the process returns to the flow in FIG. 8A.

### Determination Process in Step S3B

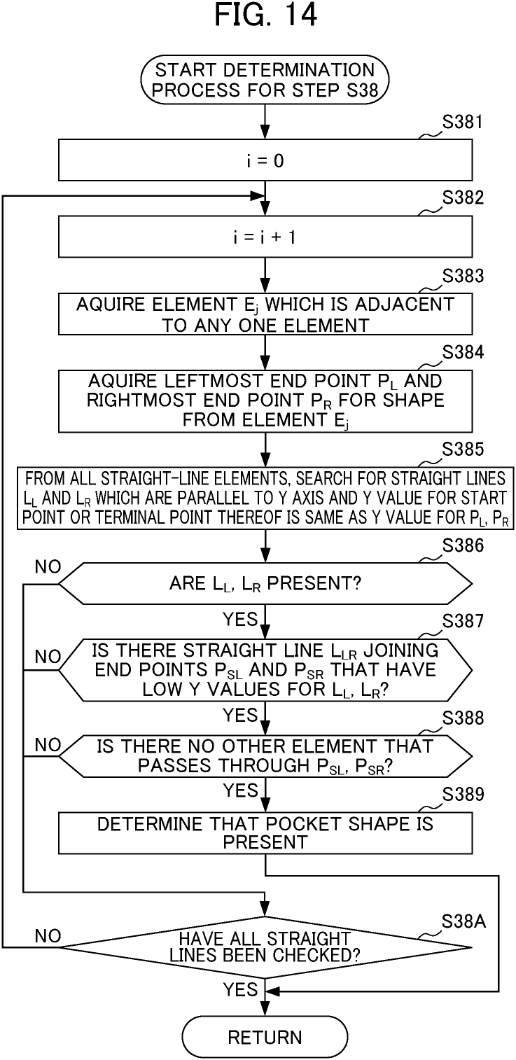

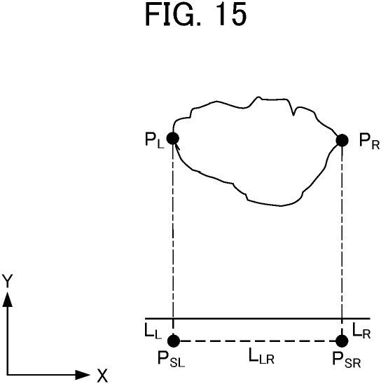

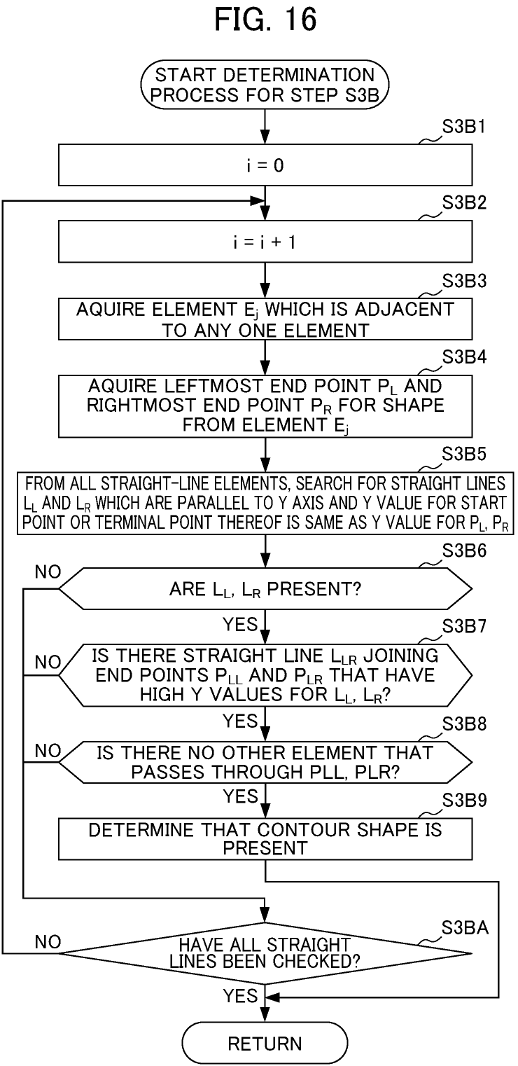

FIG. 16 is a flow chart for describing the determination process in Step S3B in FIG. 8B regarding whether a contour shape having the shape ID “4” is present in CAD data for the machining product.

Note that processing in Step S3B1 through Step S3B6, and Step S3BA is similar to processing in Step S381 through Step S386, and Step S38A in FIG. 14, and description thereof is omitted.

FIG. 17 is a view that illustrates an example of CAD data for a contour shape. The upper part in FIG. 17 illustrates a contour shape seen from above, and the lower part in FIG. 17 illustrates the contour shape seen from in front. As illustrated in FIG. 17, let a straight line that joins an end point P_{LL} with an end point P_{LR} in the X axis direction be L_{LR}.

In Step S3B7, the machinable-shape extraction unit 112 determines whether there is a straight line L_{LR} that joins the end point P_{LL}, which has a large Y value and belongs to the straight line L_{L}, with the end point P_{LR}, which has a large Y value and belongs to the straight line L_{R}. In a case where the straight line LLR is present, the process proceeds to Step S3B8. In contrast, in a case where the straight line L_{LR} is not present, the process proceeds to Step S3BA.

In Step S3B8, the machinable-shape extraction unit 112 determines whether there is no other element that passes through the end points P_{LL}, P_{LR}. In a case where there is no other element that passes through the end points P_{LL}, P_{LR}, the process proceeds to Step S3B9. In contrast, in a case where there is another element that passes through the end points P_{LL}, P_{LR}, the process proceeds to Step S3BA.

In Step S3B9, the machinable-shape extraction unit 112 determines that there is a contour shape in the CAD data for the machining product. The flow for the determination process in Step S3B ends, and the process returns to the flow in FIG. 8B.

### Determination Process in Step S3E

FIG. 18 is a flow chart for describing the determination process in Step S3E in FIG. 8B regarding whether an inclined shape having the shape ID “5” is present in CAD data for the machining product.

Note that processing in Step S3E1 through Step S3E6, and Step S3E9 is similar to processing in Step S321 through Step S326, and Step S329 in FIG. 10, and description thereof is omitted.

FIG. 19 is a view that illustrates an example of CAD data for an inclined shape. As illustrated in FIG. 19, the inclined shape is a shape resulting from obliquely inclining the hole shape in FIG. 11. Elements that are the same as elements in FIG. 11 have the same reference symbol added thereto, and description thereof is omitted.

In Step S3E7, the machinable-shape extraction unit 112 determines whether the straight line Lᵢ is not parallel to the X axis and the Y axis. In a case where the straight line Lᵢ is not parallel to the X axis and the Y axis, the process proceeds to Step S3E8. In contrast, in a case where the straight line Lᵢ is parallel to the X axis or the Y axis, the process proceeds to Step S3E9.

In Step S3E8, the machinable-shape extraction unit 112 determines that there is an inclined shape in the CAD data for the machining product. The flow for the determination process in Step S3E ends, and the process returns to the flow in FIG. 8B.

As above, based on tool information for a tool selected by the user and the association table 141, the numerical control device 10 according to the first embodiment extracts shape IDs indicating shapes that can be machined by a tool selected, and displays machinable shapes that have the extracted shape IDs. The numerical control device 10 also narrows down usable G codes based on a shape ID for a shape selected by a user from among the displayed machinable shapes, the selected tool information, and the association table 141. As a result, the numerical control device 10 can narrow down G codes and/or machining shapes according to the selected tool and display the G codes and/or machining shapes. The numerical control device 10 enables selection of machinable shapes and usable G codes to be easily performed, and can shorten an amount of time for creating a machining program.

In addition, the numerical control device 10 presents machinable shapes and usable G codes and allows a user to make a selection, whereby it is possible to prevent a machining program from being erroneously inputted.

Description was given above regarding the first embodiment.

### Second Embodiment

Next, description is given regarding a second embodiment. As described above, the numerical control device 10 according to the first embodiment stores the association table 141 that associates, in advance, tool information pertaining to a plurality of tools, shape IDs indicating shapes that the plurality of tools can respectively machine, and at least one G code that can be used to machine a shape indicated by a corresponding shape ID; extracts, based on tool information for a tool selected by a user and the association table 141, shape IDs indicating shapes that can be machined by a tool selected; and displays machinable shapes corresponding to the extracted shape IDs. The numerical control device 10 also narrows down usable G codes based on a shape ID for a shape selected by a user from among the displayed machinable shapes and the association table 141.

In contrast to this, a numerical control device 10A according to the second embodiment stores the association table 141 that associates, in advance, tool information pertaining to a plurality of tools, shape IDs indicating shapes that the plurality of tools can respectively machine, and at least one G code that can be used to machine a shape indicated by a corresponding shape ID; extracts, based on tool information for a tool selected by a user and the association table 141, G codes that can be used by a selected tool; and displays the extracted G codes. The numerical control device 10A differs from the first embodiment in further narrowing down machinable shapes based on a G code selected by a user from among the displayed G codes and the association table 141.

As a result, the numerical control device 10A can narrow down G codes and/or machining shapes according to the selected tool and display the G codes and/or machining shapes.

Description is given below regarding the second embodiment.

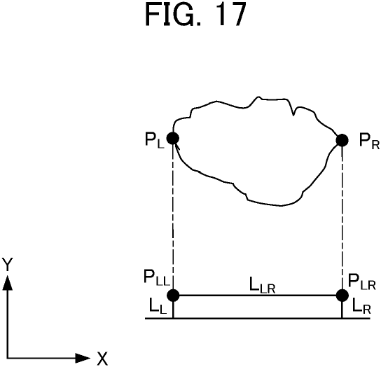

FIG. 20 is a functional block diagram illustrating an example of a functional configuration of a control system according to the second embodiment. Note that the same reference symbols are added to elements having similar functionality to elements in the control system 1 in FIG. 1, and detailed description thereof is omitted.

As illustrated in FIG. 20, a control system 1 has a numerical control device 10A and a machine tool 20.

The machine tool 20 has equivalent functionality to that of the machine tool 20 according to the first embodiment.

As illustrated in FIG. 20, the numerical control device 10A includes a control unit 11a, an input unit 12, a display unit 13, and a storage unit 14. The control unit 11a includes a tool information acquisition unit 110, a shape ID information extraction unit 111a, a machinable-shape extraction unit 112, a usable G code extraction unit 114a, a program generation unit 115, and a selected G code acquisition unit 116. In addition, the storage unit 14 includes an association table 141.

The input unit 12, the display unit 13, and the storage unit 14 have functionality equivalent to that of the input unit 12, the display unit 13, and the storage unit 14 according to the first embodiment.

In addition, the tool information acquisition unit 110, the machinable-shape extraction unit 112, and the program generation unit 115 have functionality equivalent to that of the tool information acquisition unit 110, the machinable-shape extraction unit 112, and the program generation unit 115 according to the first embodiment.

The usable G code extraction unit 114a uses the tool information acquired by the tool information acquisition unit 110 to query the association table 141, which is an associated information storage unit, and thereby extract G codes that can be used by a tool having the acquired tool information.

Specifically, for example, in a case where tool information acquired by the tool information acquisition unit 110 includes the tool number “T10”, the usable G code extraction unit 114a, based on the association table 141, extracts usable G codes - drill cycle “G81”, drill cycle “G82”, peck drilling cycle “G83”, cancel “G80”, drill cycle “G1110”, and drill cycle “G1111” - for which the G code ID “G_{id}” is “1”, as well as usable G codes - inclined surface indexing command “G68.2”, inclined surface indexing command in accordance with a tool axis direction “G68.3”, and inclined surface indexing command (incremental multiple commands) “G68.4” - for which the G code ID “G_{id}” is “5”. In addition, for example in a case where the tool information acquired by the tool information acquisition unit 110 includes the tool number “T20”, based on the association table 141, the usable G code extraction unit 114a extracts usable G codes - tapping “G84” and tapping “G1112” - for which the G code ID “G_{id}” is “2”. In addition, for example in a case where the tool information acquired by the tool information acquisition unit 110 includes the tool number “T30”, based on the association table 141, the usable G code extraction unit 114a extracts usable G codes - pocketing rough machining “G1040”, pocketing bottom surface finishing “G1041”, and pocketing side surface finishing “G1042” - for which the G code ID “G_{id}” is “3”, and usable G codes - contouring outer wall rough machining “G1060”, contouring outer wall bottom surface finishing “G1061”, and contouring outer wall side surface finishing “G1062” - for which the G code ID “G_{id}” is “4”.

The display unit 13 which serves as a usable G code display unit displays the usable G codes that were extracted by the usable G code extraction unit 114a.

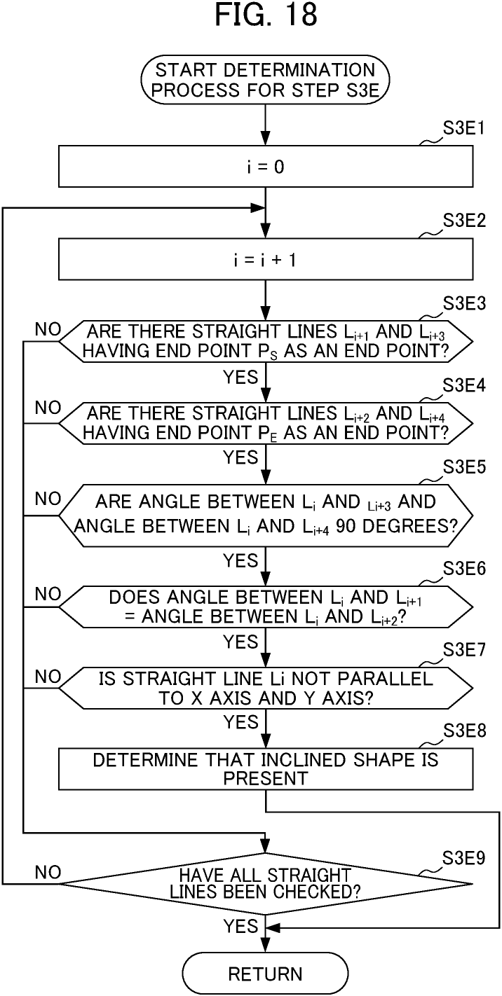

FIG. 21 is a view that illustrates an example of a display screen for display of usable G codes.

For example, in a case where an end mill having the tool number “T30” is selected by a user as a tool, as illustrated in FIG. 21, the display unit 13 which serves as a usable G code display unit displays G codes: pocketing rough machining “G1040”, pocketing bottom surface finishing “G1041”, pocketing side surface finishing “G1042”, contouring outer wall rough machining “G1060”, contouring outer wall bottom surface finishing “G1061”, and contouring outer wall side surface finishing “G1062”.

For example, in a case where a user has selected a G code, via the input unit 12 which serves as a G code selection acceptance unit, on the display screen in FIG. 21 displayed on the display unit 13 which serves as a usable G code display unit, the selected G code acquisition unit 116 acquires the selected G code. The selected G code acquisition unit 116 outputs the acquired G code, together with the tool information acquired by the tool information acquisition unit 110, to the shape ID information extraction unit 111a, which is described below.

The shape ID information extraction unit 111a uses the tool information and G code received from the selected G code acquisition unit 116 to query the association table 141 which serves as an associated information storage unit and further narrows down shape IDs for shapes that can be machined by the tool corresponding to the received tool information using the received G code.

Specifically, for example in a case where the tool number “T10” acquired by the tool information acquisition unit 110 and the peck drilling cycle “G83” G code selected by the user via the input unit 12 which serves as a G code selection acceptance unit are received from the selected G code acquisition unit 116, the shape ID information extraction unit 111a extracts and narrows down to the shape ID (Sid) “1” based on the association table 141. In addition, for example in a case where the tool number “T20” acquired by the tool information acquisition unit 110 and the tapping ring “G84” G code selected by the user via the input unit 12 which serves as a G code selection acceptance unit are received from the selected G code acquisition unit 116, the shape ID information extraction unit 111a extracts and narrows down to the shape ID (Sid) “2” based on the association table 141. In addition, for example in a case where the tool number “T30” acquired by the tool information acquisition unit 110 and the pocketing rough machining “G1040” G code selected by the user via the input unit 12 which serves as a G code selection acceptance unit are received from the selected G code acquisition unit 116, the shape ID information extraction unit 111a extracts and narrows down to the shape ID (Sid) “3” based on the association table 141. In addition, for example in a case where the tool number “T30” acquired by the tool information acquisition unit 110 and the contouring outer wall rough machining “G1060” G code selected by the user via the input unit 12 which serves as a G code selection acceptance unit are received from the selected G code acquisition unit 116, the shape ID information extraction unit 111a extracts and narrows down to the shape ID (Sid) “4” based on the association table 141. In addition, for example in a case where the tool number “T10” acquired by the tool information acquisition unit 110 and the inclined surface indexing command “G68.2” G code selected by the user via the input unit 12 which serves as a G code selection acceptance unit are received from the selected G code acquisition unit 116, the shape ID information extraction unit 111a extracts and narrows down to the shape ID (Sid) “5” based on the association table 141.

Based on the shape IDs narrowed down by the shape ID information extraction unit 111a described above, the display unit 13 which serves as a machinable-shape display unit displays machinable shapes extracted from CAD data for a machining product by the machinable-shape extraction unit 112.

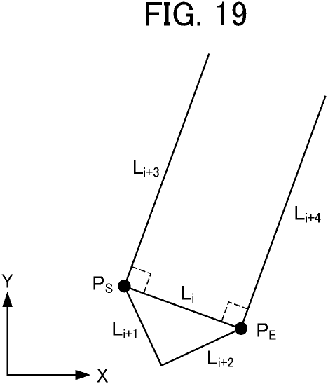

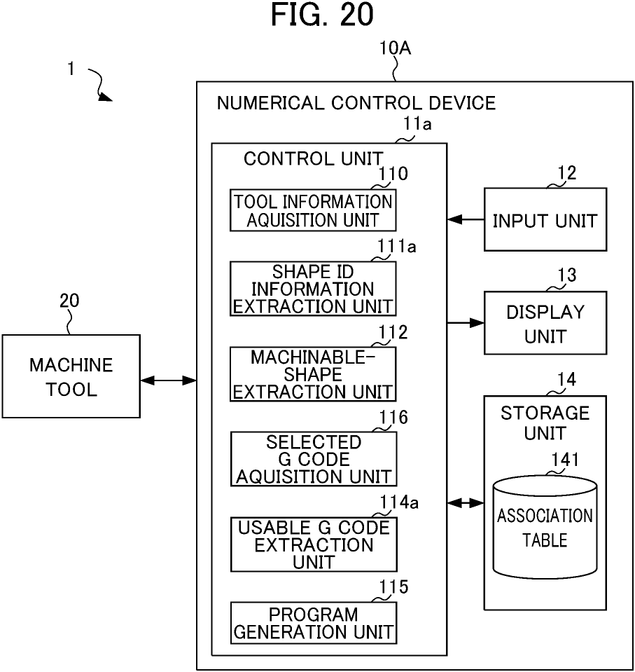

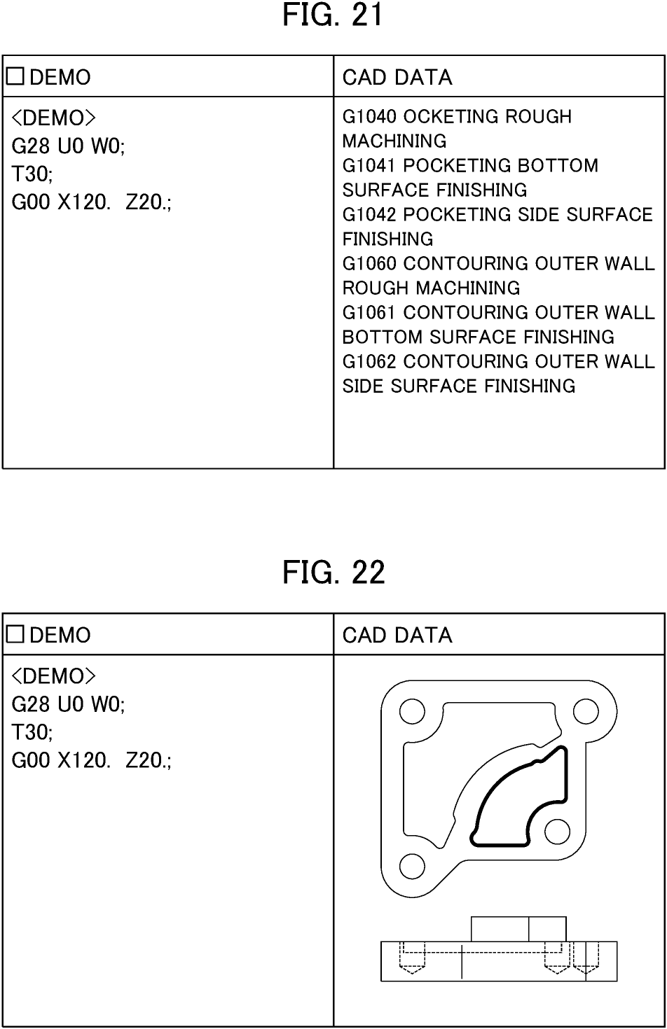

FIG. 22 is a view that illustrates an example of a display screen for extracted machinable shapes.

For example, in a case where the contouring outer wall rough machining “G1060” G code is selected by a user in FIG. 21, the shape ID information extraction unit 111a extracts the shape ID “4”. The machinable-shape extraction unit 112 extracts only contour shapes which have the shape ID “4”, in CAD data illustrated in FIG. 28A and FIG. 28B. As illustrated in FIG. 22, the display unit 13 which serves as a machinable-shape display unit may display an extracted contour shape emphasized by a thick line.

As a result, the numerical control device 10A enables selection of a G code and a machining shape to be easily performed, and can shorten an amount of time for creating a machining program. In addition, the numerical control device 10A presents available G codes and machinable shapes and allows a user to make a selection, whereby it is possible to prevent a machining program from being erroneously inputted.

Note that the display unit 13 which serves as a machinable-shape display unit has displayed an extracted machining shape emphasized by a thick line, but an emphasized display may be performed by a line other than a thick line, or an emphasized display may be performed by a line having a color such as red.

### Machining Program Generation Process by Numerical Control Device 10A

Next, with reference to FIG. 23, a flow for a machining program generation process by the numerical control device 10A is described.

FIG. 23 is a flow chart for describing a machining program generation process by the numerical control device 10A. The flow illustrated here is executed each time a machining program is generated.

In Step S′1, the tool information acquisition unit 110, based on an input operation by a user via the input unit 12, performs a tool information acquisition process similar to that for Step S1 in the first embodiment to acquire tool information (for example, a tool number, tool type, etc.).

In Step S′2, the usable G code extraction unit 114a uses the tool information acquired in Step S′1 to query the association table 141, which is an associated information storage unit, and thereby extract G codes that can be used by a tool having the acquired tool information.

In Step S′3, the display unit 13 which serves as a usable G code display unit displays (for example, FIG. 21) the usable G codes which were extracted in Step S′2.

In Step S′4, the selected G code acquisition unit 116 acquires a G code selected by a user, via the input unit 12 which serves as a G code selection acceptance unit, on a display screen (for example, FIG. 21) displayed on the display unit 13 which serves as a usable G code display unit.

In Step S′5, the shape ID information extraction unit 111a uses the tool information acquired in Step S′1 and the G code selected in Step S′4 to query the association table 141 and thereby further narrow down shape IDs indicating shapes that can be machined by the tool corresponding to the acquired tool information and using the selected G code.

In Step S′6, based on the shape IDs extracted in Step S′5, the machinable-shape extraction unit 112 performs a machinable-shape extraction process, similar to that in Step S3 in the first embodiment, and extracts machinable shapes from CAD data for a machining product to be achieved.

In Step S′7, the display unit 13 which serves as a machinable-shape display unit displays (for example, FIG. 22) the machinable shapes extracted in Step S′6.

In Step S′8, the program generation unit 115 accepts a shape selected by a user, via the input unit 12 which serves as a shape selection acceptance unit, on a display screen displayed on the display unit 13 which serves as a machinable-shape display unit.

In Step S′9, in order to machine the shape accepted in Step S′8, the program generation unit 115 displays a setting screen (for example, FIG. 24) for the G code selected in Step S′4 on the display unit 13, and accepts a parameter inputted by the user via the input unit 12.

FIG. 24 is a view that illustrates an example of a setting screen for a case of the contouring outer wall rough machining “G1060” G code.

In Step S′10, the program generation unit 115 uses the parameter inputted by the user in Step S′9 to add a block that includes the selected G code.

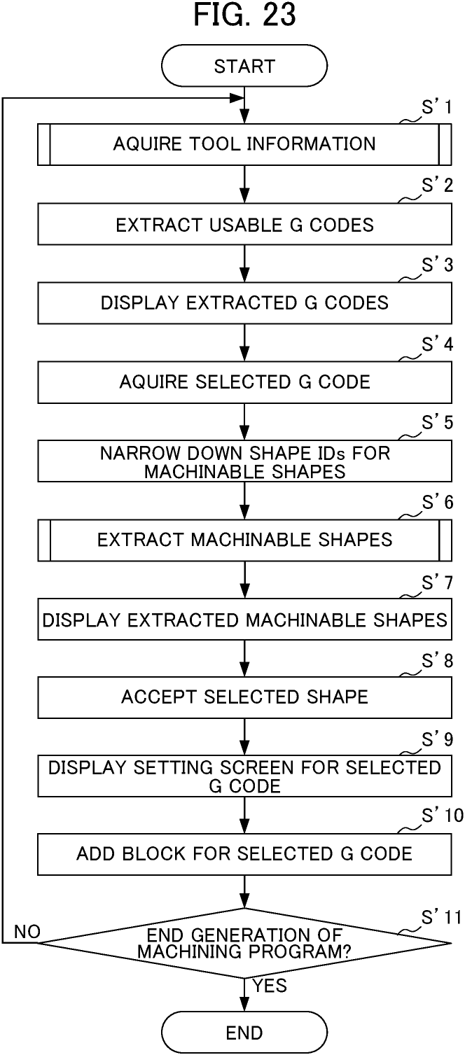

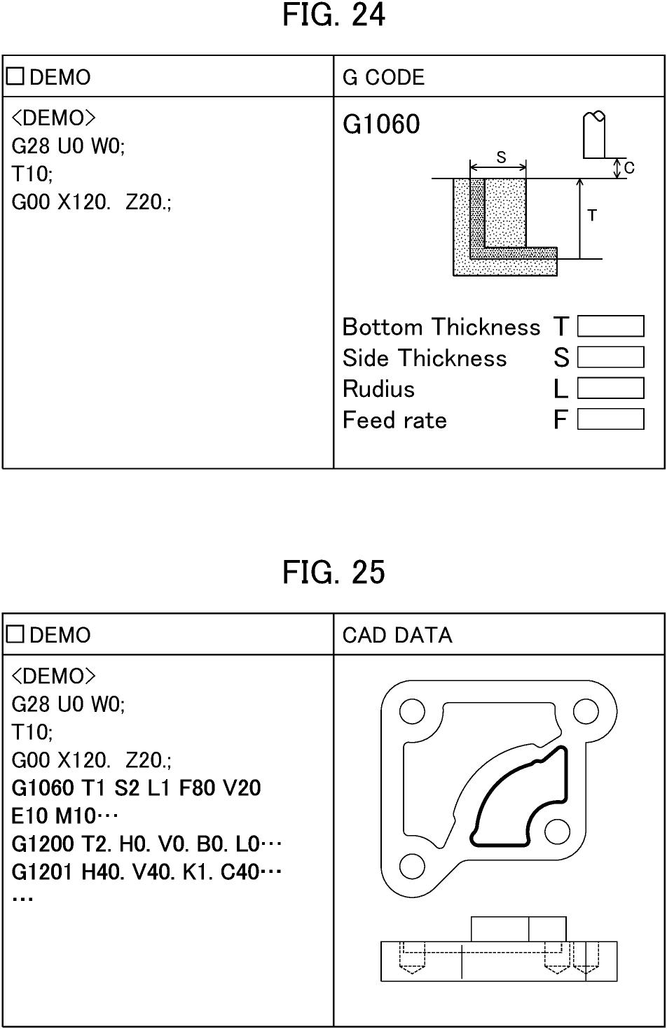

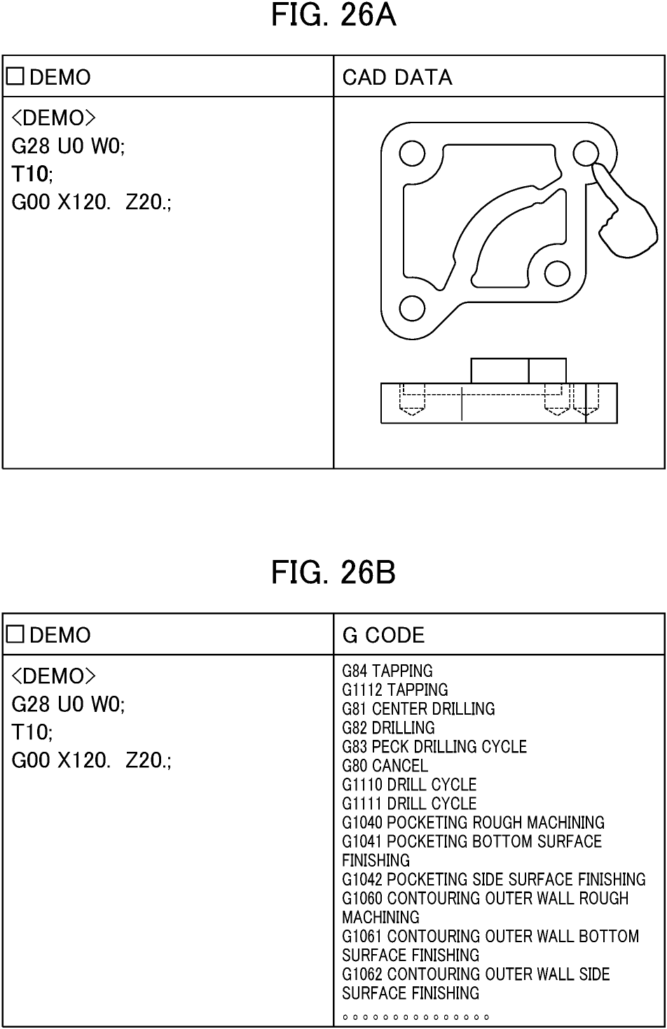

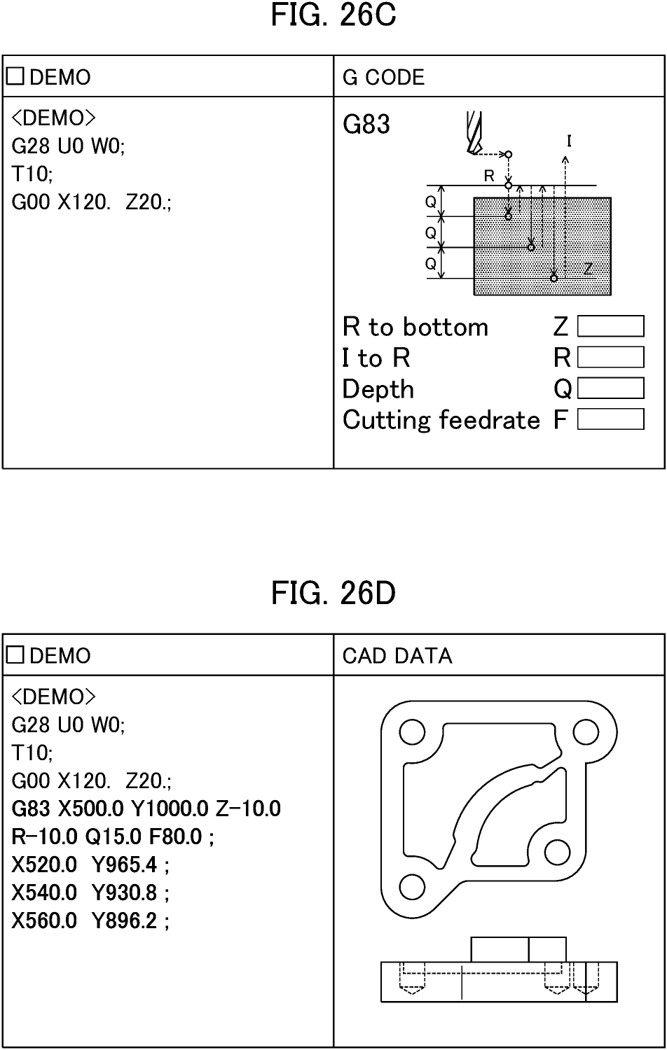

FIG. 25 is a view that illustrates an example of screen in which a block for the selected G code has been added. Note that “G1200” is a G code for setting a start point for contouring, and “G1201” is a G code for setting a straight line in contouring.

In Step S′11, the program generation unit 115 determines whether generation of the machining program has ended, similarly to Step S11 in the first embodiment. In a case where an input such as “save” or “end” for the machining program is accepted from a user via the input unit 12, the program generation unit 115 determines that generation of the machining program has ended, and ends the processing. In contrast, in a case where an input such as “save” or “end” for the machining program is not accepted from a user via the input unit 12, the program generation unit 115 determines that generation of the machining program has not ended, and returns the processing to Step S′1.

As above, based on tool information for a tool selected by a user and the association table 141, the numerical control device 10A according to the second embodiment extracts G codes that can be used by the selected tool, and displays the extracted usable G codes. Based on a G code selected by the user from among the displayed usable G codes, the selected tool information, and the association table 141, the numerical control device 10 further narrows down machinable shapes. As a result, the numerical control device 10A can narrow down G codes and/or machining shapes according to the selected tool and display the G codes and/or machining shapes. The numerical control device 10A enables selection of machinable machining shapes and usable G codes to be easily performed, and can shorten an amount of time for creating a machining program.

In addition, the numerical control device 10A presents machinable machining shapes and usable G codes and allows a user to make a selection, whereby it is possible to prevent a machining program from being erroneously inputted.

Description was given above regarding the second embodiment.

This concludes the description above regarding the first embodiment and the second embodiment, but the numerical control devices 10 and 10A is not limited to the embodiments described above, and include variations, improvements, etc. in a scope that enables the objective to be achieved.

### Variation

In the first embodiment and second embodiment described above, the numerical control devices 10 and 10A are given as devices that differ to the machine tool 20, but there is no limitation to this. For example, the numerical control devices 10 and 10A may be included in the machine tool 20.

In a case of configuring all or some of the numerical control devices 10 and 10A by software, a computer is configured by a storage unit such as a hard disk or a ROM that stores a program in which is written all of some of the operations by the numerical control devices 10 and 10A, a DRAM that stores data necessary for computation, a CPU, and a bus that connects each unit, and realization is possible in the computer by storing information necessary for computation in the DRAM and causing the program to be run by the CPU.

The program can be stored using various types of non-transitory computer-readable mediums and supplied to the computer. A non-transitory computer-readable medium includes various types of tangible storage mediums. An example of a non-transitory computer-readable medium includes a magnetic recording medium (for example, a floppy disk, magnetic tape, or a hard disk drive), a magneto-optical recording medium (for example, a magneto-optical disk), a CD-ROM (read-only memory), CD-R, CD-R/W, and a semiconductor memory (for example, a mask ROM, a programmable ROM (PROM), an erasable PROM (EPROM), a flash ROM, or a RAM). In addition, the program may be supplied to the computer by various types of transitory computer-readable mediums. An example of a transitory computer-readable medium includes an electrical signal, an optical signal, and electromagnetic waves. A transitory computer-readable medium can supply the program to the computer via wired communication channel such as an electrical wire or an optical fiber, or via a wireless communication channel.

In addition, these programs may be distributed by being downloaded to the computer, which belongs to a user, via a network.

Note that steps that express a program recorded to a recording medium of course include processing in chronological order following the order of these steps, but also include processing that is executed in parallel or individually, with no necessity for processing to be performed in chronological order.

To rephrase, the numerical control device according to the present disclosure can have various embodiments which have configurations such as the following.

(1) The numerical control device 10 according to the present disclosure is a numerical control device configured to automatically generate a machining program, the device comprising: the storage unit 14 configured to store the association table 141 resulting from associating, in advance, tool information pertaining to a plurality of tools, shape IDs indicating shapes that the plurality of tools can respectively machine, and at least one G code that can be used to machine a shape indicated by a shape ID; the tool information acquisition unit 110 configured to acquire tool information pertaining to a tool selected for machining; the shape ID information extraction unit 111 configured to, using the acquired tool information to query the association table 141, extract a shape ID indicating a shape that can be machined by the tool corresponding to the acquired tool information; the machinable-shape extraction unit 112 configured to, based on the extracted shape ID, extract a machinable shape from CAD data; and the display unit 13 which serves as a machinable-shape display unit configured to display the extracted machinable shape.

By virtue of this numerical control device 10, it is possible to narrow down G codes and/or machining shapes according to the selected tool so as to display the G codes and/or machining shapes.

(2) The numerical control device 10 according to (1) may further be provided with: the input unit 12 which serves as a shape selection acceptance unit configured to select the extracted machinable shape; the selected-shape acquisition unit 113 configured to acquire a shape ID for the selected machinable shape; and the usable G code extraction unit 114 configured to, using the shape ID for the machinable shape acquired by the selected-shape acquisition unit 113 and the acquired tool information to query the association table 141, further narrow down G codes that can be used to machine the shape corresponding to the acquired shape ID by the tool corresponding to the acquired tool information.

As a result, the numerical control device 10 enables selection of machinable machining shapes and usable G codes to be easily performed, and can shorten an amount of time for creating a machining program.

(3) The numerical control device 10 according to (2) may further be provided with: the display unit 13 which serves as a usable G code display unit configured to display the G codes that can be used and were narrowed down by the usable G code extraction unit 114; and the input unit 12 which serves as a G code selection acceptance unit configured to select a G code from the displayed G codes that can be used.

As a result, the numerical control device 10 presents machinable machining shapes and usable G codes and allows a user to make a selection, whereby it is possible to prevent a machining program from being erroneously inputted.

(4) The numerical control device 10A according to the present disclosure is a numerical control device configured to automatically generate a machining program, the device comprising: the storage unit 14 configured to store the association table 141 resulting from associating, in advance, tool information pertaining to a plurality of tools, shape IDs indicating shapes that the plurality of tools can respectively machine, and at least one G code that can be used to machine a shape indicated by a shape ID; the tool information acquisition unit 110 configured to acquire tool information pertaining to a tool selected for machining; the usable G code extraction unit 114a configured to, using the acquired tool information to query the association table 141, extract a G code that can be used by the tool corresponding to the acquired tool information; and the display unit 13 which serves as a usable G code display unit configured to display the extracted G code that can be used.

By virtue of this numerical control device 10A, an equivalent effect to that for (1) can be achieved.

(5) The numerical control device 10A according to (4) may further be provided with: the input unit 12 which serves as a G code selection acceptance unit configured to select the extracted G code that can be used; the selected G code acquisition unit 116 configured to acquire the selected G code that can be used; and the shape ID information extraction unit 111a configured to, using the G code that can be used and was acquired by the selected G code acquisition unit 116 and the acquired tool information to query the association table 141, further narrow down a shape ID indicating a shape that can be machined by the tool corresponding to the acquired tool information using the selected G code that can be used.

As a result, the numerical control device 10A can achieve an equivalent effect to that for (2).

(6) The numerical control device 10A according to (5) may further be provided with: the machinable-shape extraction unit 112 configured to, based on the shape ID narrowed down by the shape ID information extraction unit 111a, extract from CAD data a shape that can be machined; and the display unit 13 which serves as a machinable-shape display unit configured to display the extracted shape that can be machined.

As a result, the numerical control device 10A can achieve an equivalent effect to that for (3).

### EXPLANATION OF REFERENCE NUMERALS

1 Control system
10, 10A Numerical control device
11, 11a Control unit
110 Tool information acquisition unit
111, 111a Shape ID information extraction unit
112 Machinable-shape extraction unit
113 Selected-shape acquisition unit
114, 114a Usable G code extraction unit
115 Program generation unit
116 Selected G code acquisition unit
12 Input unit
13 Display unit
14 Storage unit
141 Association table
20 Machine tool

1. A numerical control device configured to automatically generate a machining program, the numerical control device comprising:
an associated information storage unit configured to store associated information resulting from associating, in advance, tool information pertaining to a plurality of tools, shape identifiers indicating shapes that the plurality of tools can respectively machine, and at least one G code that can be used to machine the shape indicated by the shape identifier;
a tool information acquisition unit configured to acquire tool information pertaining to a tool selected for machining;
a shape ID information extraction unit configured to, using the acquired tool information to query the associated information storage unit, extract a shape identifier indicating a shape that can be machined by the tool corresponding to the acquired tool information;
a machinable-shape extraction unit configured to, based on the extracted shape identifier, extract a machinable shape from CAD data; and
a machinable-shape display unit configured to display the extracted machinable shape.

2. The numerical control device according to claim 1, further comprising:
a shape selection acceptance unit configured to select the extracted machinable shape;
a selected-shape acquisition unit configured to acquire a shape identifier for the selected machinable shape; and
a usable G code extraction unit configured to, using the shape identifier for the machinable shape acquired by the selected-shape acquisition unit and the acquired tool information to query the associated information storage unit, further narrow down G codes that can be used to machine the shape corresponding to the acquired shape identifier by the tool corresponding to the acquired tool information.

3. The numerical control device according to claim 2, further comprising:
a usable G code display unit configured to display the G codes that can be used and were narrowed down by the usable G code extraction unit; and
a G code selection acceptance unit configured to select a G code from the displayed G codes that can be used.

4. A numerical control device configured to automatically generate a machining program, the numerical control device comprising:
an associated information storage unit configured to store associated information resulting from associating, in advance, tool information pertaining to a plurality of tools, shape identifiers indicating shapes that the plurality of tools can respectively machine, and at least one G code that can be used to machine the shape indicated by the shape identifier;
a tool information acquisition unit configured to acquire tool information pertaining to a tool selected for machining;
a usable G code extraction unit configured to, using the acquired tool information to query the associated information storage unit, extract a G code that can be used by the tool corresponding to the acquired tool information; and
a usable G code display unit configured to display the extracted G code that can be used.

5. The numerical control device according to claim 4, further comprising:
a G code selection acceptance unit configured to select the extracted G code that can be used;
a selected G code acquisition unit configured to acquire the selected G code that can be used; and
a shape ID information extraction unit configured to, using the G code that can be used and was acquired by the selected G code acquisition unit and the acquired tool information to query the associated information storage unit, further narrow down a shape identifier indicating a shape that can be machined by the tool corresponding to the acquired tool information using the selected G code that can be used.

6. The numerical control device according to claim 5, further comprising:
a machinable-shape extraction unit configured to, based on the shape identifier narrowed down by the shape ID information extraction unit, extract from CAD data a shape that can be machined; and
a machinable-shape display unit configured to display the extracted shape that can be machined.
